(19) United States
(12) Patent Application Publication
(10) Pub. No.: US 2007/0188656 A1
(43) Pub. Date: Aug. 16, 2007

(54) Content reproducing device, broadcast content transmitting device, control data providing device, user attribute value providing device, broadcast system, content reproducing method, and broadcast content transmitting method

(75) Inventor: Masanobu Chisaka, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/368,456

(22) Filed: Mar. 7, 2006

(30) Foreign Application Priority Data
Feb. 15, 2006 (JP) 2006-038506

(51) Int. Cl. H04N 11/00; H04N 7/00

(52) U.S. Cl. 348/464

(57) ABSTRACT

A content reproducing device according to the present invention is provided with (a) a broadcast wave receiving section for receiving a broadcast content together with a sync signal(s) multiplexed on the broadcast content, (b) a sync signal extracting section for reproducing the broadcast content immediately after the broadcast content is received by the broadcast wave receiving section, and (c) a control section for controlling the content reproducing device in accordance with the sync signal in synchronism with the reproduction of the broadcast content.

This Nonprovisional application claims priority under 35 U.S.C. § 119(a) on Patent Application No. 038506/2006 filed in Japan on Feb. 15, 2006, the entire contents of which are hereby incorporated by reference.

### FIELD OF THE INVENTION

The present invention relates to a content reproducing device for reproducing a stored-type content in synchronism with reproduction of the broadcast content.

### BACKGROUND OF THE INVENTION

Content reproducing devices are widely used, which receive and display a broadcast program, such as television receivers and the like, which receives a broadcast program superimposed on a carrier wave and displays the broadcast program. There are various distribution methods today, such as distributing streams of contents via the Internet, and the like method. The various distribution methods use content reproducing devices suitable to them. Recently, content reproducing devices have been developed which are provided with storage medium of large capacity, so that they can store the distributed content in the storage medium and reproduce the stored content. Further, content reproducing devices of portable sizes, such as portable telephone terminals capable of reproducing the broadcast content have been developed.

The content can be reproduced can be reproduced at any time once it is stored in the storage medium. Some known techniques utilize this advantage of the stored content. In these techniques, the broadcast content is once stored. The stored broadcast content is reproduced in such a manner that a stored content acquired by a way different from broadcasting is inserted in the stored broadcast content at an arbitrary timing or predetermined timing.

Japanese Unexamined Patent publication, Tokukaisho, No. 61-111079 (published on May 29, 1986), discloses a technique in which image information is automatically displayed when no image is received, the image information being stored in an image memory in advance.

Moreover, Japanese Unexamined Patent publication, Tokukaihei, No. 10-013811 (published on Jan. 16, 1998), discloses a receiver device which while reproducing the stored broadcast content, reads out service-adding information (stored-type content) if necessary, and performs various tasks. Specifically, the service-adding information contains a program to be run on the receiver device, moving picture data, still image data, or the like.

Moreover, Japanese Unexamined Patent publication, Tokukai, No. 2004-088630 (published on Mar. 18, 2004), discloses a technique in which stored content data (broadcast content) is outputted in such a manner that CM (commercial) data is inserted at a CM insertion mark (which indicates a point at which CM can be inserted) in the content data. The CM data is stored in advance in a CM data storage medium. An amount of the CM data to be inserted is determined by a user's side.

Moreover, Japanese Unexamined Patent publication, Tokukai, No. 2004-194302 (published on Mar. 18, 2004), discloses a technique in which reproduction is switched over depending on at least one of reproduction status of a stored content and reception status of receiving content.

Moreover, Japanese Unexamined Patent publications, Tokukai, No. 2005-244946 (published on Sep. 8, 2005) and No. 2005-175963 (published on June 30), disclose techniques for reproducing stored content, even though reproduction timing is not involved in these techniques.

According to these techniques, it is possible to reproduce the stored content in association with reproduction of a broadcast content, and the broadcast content can be reproduced with various additional values.

However, the conventional arts have difficulties in performing various processes such as processes regarding the stored content in synchronism with the broadcast content that is reproduced in real time immediately after reception of the broadcast content.

This problem is explained below, discussing a case where the stored content is reproduced in replacement of a particular part of the broadcast content.

In case where the broadcast content is stored in a recording medium temporally and then reproduced, it is relatively easy to switch from the reproduction of the stored content to the reproduction of the broadcast content at a predetermined timing, because it is possible to arbitrarily adjust the timing of the reproduction of the broadcast content stored in the recording medium. For example, if the reproduction is switched from the reproduction of the stored content to the reproduction of the broadcast content, it is possible to delay start of the reproduction of the broadcast content to any time. Thus, the reproduction of the broadcast content can be started after the completion of the reproduction of the stored content being reproduced before the reproduction of the broadcast content.

On the other hand, if the broadcast content is reproduced in real time immediately after the reception thereof, it is difficult to switch the reproduction from reproducing the stored content to reproducing the broadcast content. This is because, for example, if the completion of the reproduction of the stored content is delayed from an expected completion time to a delayed completion time, it is impossible to reproduce the broadcast content broadcast from the expected completion time to the delayed completion time. Moreover, if the stored content has a certain reproduction time (duration), it is necessary to accurately control the timing of the switching from reproducing the broadcast content to reproducing the stored content (i.e., the timing of the starting the reproduction of the stored content), otherwise switching back to the reproduction of the broadcast content after the completion of the reproduction of the stored content would be off the timing.

Moreover, in broadcast services, which broadcast the same data to an unspecified number of content reproducing devices or multicast the same data to a specified number of content reproducing devices, it is difficult to cause each content reproducing device to perform different processes individually in association with the broadcast content that is reproduced in real time. That is, it is difficult to established in a unicast-like service in such broadcast services.

### SUMMARY OF THE INVENTION

An object of the present invention is to provide a content reproducing device and a content reproducing method, each of which can perform various processes in synchronism with a broadcast content reproduced immediately after reception thereof (i.e., real-time reproduction).

Moreover, an object of the present invention is to provide a broadcast content transmitting device and a broadcast content transmitting method, each of which can control the content reproducing device to perform the various processes in synchronism with the broadcast content reproduced by the content reproducing device.

Furthermore, an object of the present invention is to provide a broadcast system including the broadcast content transmitting device and the content reproducing device. Further, an object of the present invention is to provide a control data providing device and a use attribute value providing device, which are applicable to the system.

In order to attain the object, a content reproducing device according to the present invention is provided with: a broadcast content receiving section for receiving a broadcast content together with a sync signal(s) multiplexed on the broadcast content; a broadcast content reproducing section for reproducing the broadcast content immediately after the broadcast content receiving section received the broadcast content; and a control section for controlling the content reproducing device in synchronism with the reproduction of the broadcast content in accordance with at least one of the sync signal(s).

According to this arrangement, the broadcast content reproducing section reproduces the broadcast content immediately after the reception thereof. On the other hand, the control section controls the content reproducing section in synchronism with the sync signal(s) that are received together with the broadcast content.

Therefore, according to this arrangement, the broadcast content transmitting device broadcasts the broadcast content together with the sync signal(s) thereby transmitting the broadcast content and the sync signal in synchronism at an arbitrary timing. The content reproducing device can perform the control in accordance with the sync signal(s) in synchronism with the reproduced broadcast content at the same timing at which the transmission was carried out. Therefore, with this arrangement, it is possible to provide a content reproducing device capable of performing various processes under the control of the control section in synchronism with the broadcast content reproduced immediately after the reception of the broadcast content.

To “reproduce the broadcast content by the content reproducing device immediately after the reception of the broadcast content” is to reproduce the broadcast content immediately after the reception thereof, i.e., without storing the stored broadcast content in a hard disc or the like. Note that, storing the broadcast content temporally in a buffer memory is excluded from this “storing”.

The broadcasting encompasses (a) wireless broadcasting such as analog terrestrial broadcasting, digital terrestrial broadcasting, satellite broadcasting (such as BS broadcasting), and the like broadcasting, in which electromagnetic waves are utilized, (b) cable broadcasting such as cable television and the like, (c) broadcasting service by which a stream of broadcast content is distributed via a network such as the Internet.

Moreover, apart from the processes regarding the stored-type content, the process to be realized under the control of the control section may be (i) starting/stopping of reproduction of sound (or melody) that signals reception of, e.g., a content, (ii) starting/stopping reproduction of an image that signals the reception of, e.g., a content, (iii) starting/stopping recording of a broadcast content, (iv) setting a volume, (v) and the like processes.

In order to attain the object, a broadcast content transmitting device according to the present invention is provided with: a sync signal generating section for generating a sync signal(s) for causing a content reproducing device to operate in synchronism with reproduction of the broadcast content, the content reproducing device reproducing a broadcast content immediately after reception of the broadcast content; and a broadcast content transmitting section for transmitting the broadcast content together with the sync signal(s) multiplexed on the broadcast content.

With this arrangement, the broadcast content transmitting device transmits, to the content reproducing device, a sync signal for causing the content reproducing device to operate in synchronism with the reproduction of the broadcast content. The sync signal multiplexed on the broadcast content is transmitted.

According to this arrangement, the broadcast content transmitting device transmits the broadcast content and the sync signal in synchronism at an arbitrary timing. The content reproducing device, which reproduces the broadcast content immediately after the reception thereof, can synchronize, at the same timing as the transmission, the reproduced broadcast content and a process that is to be performed according to the sync signal.

That is, this arrangement allows the broadcast content transmitting device to control the content reproducing device to synchronize the processes to be performed by the content reproducing device with the broadcast content that is being reproduced.

The broadcasting encompasses (a) wireless broadcasting such as analog terrestrial broadcasting, digital terrestrial broadcasting, satellite broadcasting (such as BS broadcasting), and the like broadcasting, in which electromagnetic waves are utilized, (b) cable broadcasting such as cable television and the like, (c) broadcasting service by which a stream of broadcast content is distributed via a network such as the Internet.

The sync signal generating section and the broadcast content transmitting section may be arranged separately. That is, for example, the sync signal generating section may be provided in a broadcast program providing center at which the broadcast contents are created, while the broadcast content transmitting section may be provided in a broadcast base station device provided outside of the broadcast program providing center.

In order to attain the object, a control data providing device is provided with: a control data generating section for generating control data that designates which process to be performed by the content reproducing device in synchronism with the sync signal(s) when the content reproducing device receives the broadcast content together with the sync signal(s); and a control data transmitting section for transmitting the control data to the content reproducing device.

According to this arrangement, the control data designates the process to be performed by the content reproducing device when the content reproducing device receives the sync signal. Therefore, with the control data providing device having this arrangement, the process to be performed by the content reproducing device can be designated by providing the control data to the content reproducing device.

In order to attain the object, a user attribute value providing device according to the present invention is provided with: an operation information receiving section for receiving operation information from a content reproducing device; a user attribute value setting section for setting a user attribute value based on the operation information; and a user attribute value transmitting section for transmitting the user attribute value to the content reproducing device, the content reproducing device performing a process according to the user attribute value in synchronism with reproduction of a broadcast content.

With this arrangement, the user attribute value providing device acquires the operation information from the content reproducing device, and sets the user attribute value based on the operation information. Then, the user attribute value thus set is transmitted to the content reproducing device by the user attribute value transmitting section. Therefore, the content reproducing device can acquire the user attribute value without performing the process of setting the user attribute value by itself. That is, with this arrangement, it is possible to cause the content reproducing device to perform a process in accordance with the user attribute value without causing the content reproducing device to perform the process of setting the user attribute value.

The user attribute providing device may be provided with storage section for storing a look-up table that shows association between possible details of the user's operation and particular user attribute values, or acquiring section for externally acquiring the look-up table, the user attribute value setting section setting the user attribute values by reference to the look-up table.

Alternatively, the user attribute value setting section may perform a predetermined calculation to work out the user attribute values from the possible details of the user's operation thereby to set the user attribute value.

For example, in case where the user inputs an answer for a question asked in a quiz program (broadcast content), the look-up table may be such that 1 is allocated to a correct answer and 0 is allocated to a wrong answer. By referring to the look-up table, the user attribute value setting section can set the user attribute value to 1 for the input of a correct answer, but set the user attribute value to 0 for the input of a wrong answer.

A broadcast system according to the present invention includes a broadcast content transmitting device for transmitting a broadcast content, and a content reproducing device for reproducing the broadcast content immediately after receiving the broadcast content. In order to attain the object, broadcast system according to the present invention is arranged such that the broadcast content transmitting device includes: a sync signal generating section for generating sync signal(s) for causing the content reproducing device to operate in synchronism with the reproduction of the broadcast content; and a broadcast content transmitting section for transmitting the broadcast content together with the sync signal(s) multiplexed on the broadcast content, and the content reproducing device includes: a broadcast content receiving section for receiving the broadcast content together with sync signal(s) multiplexed on the broadcast content; a broadcast content reproducing section for reproducing the broadcast content received by the broadcast content receiving section; and a control section for controlling the content reproducing device in synchronism with the reproduction of the broadcast content in accordance with at least one of the sync signal(s).

With this arrangement, the content reproducing device performs, in synchronism with the sync signal multiplexed on the broadcast content, various processes that are realized under the control of the control section. This arrangement realizes a broadcast system in which the broadcast content is broadcast together with the sync signal by the broadcast content transmitting device, and the broadcast content transmitting device transmits the broadcast content and the sync signal at an arbitral timing; and the content reproducing device can synchronize, at the same timing as the transmission, various processes that are to be performed according to the sync signal, and the reproduced broadcast content.

A broadcast system according to the present invention includes a broadcast content transmitting device for transmitting a broadcast content, and a content reproducing device for reproducing the broadcast content immediately after receiving the broadcast content. In order to attain the object, the broadcast system according to the present invention is arranged such that the broadcast content transmitting device includes: a sync signal generating section for generating sync signal(s) for causing the content reproducing device to operate in synchronism with the reproduction of the broadcast content; and a broadcast content transmitting section for transmitting the broadcast content together with the sync signal(s) multiplexed on the broadcast content, the content transmitting section transmitting a first sync signal before transmitting a second sync signal, where the first sync signal is a sync signal that causes the content reproducing device to be standby so that the content reproducing device is capable of starting reproduction of a stored-type content immediately, and the second sync signal is a sync signal that causes the content reproducing device to start the reproduction of the stored-type content, the content reproducing device includes: a broadcast content receiving section for receiving the broadcast content together with sync signal(s) multiplexed on the broadcast content; a broadcast content reproducing section for reproducing the broadcast content received by the broadcast content receiving section; and a control section for controlling the content reproducing device in synchronism with the reproduction of the broadcast content in accordance with at least one of the sync signal(s), and the control section includes: a stored-type content reproducing section, which starts the reproduction of the stored-type content when the broadcast content receiving section receives a second sync signal; and a reproduction preparing section, which when the broadcast content receiving section receives a first sync signal before the second sync signal, causes the stored-type content reproducing section to be standby so that the stored-type content reproducing section is capable of starting the reproduction of the stored-type immediately.

This arrangement realizes a broadcast system in which the broadcast content transmitting device broadcasts the broadcast content together with the sync signal by transmitting the broadcast content and the sync signal in synchronism at an arbitrary timing; and the content reproducing device can synchronize, at the same timing as the transmission, the reproduced broadcast content and the stored-type content process, which is performed according to the sync signal.

Even if the second signal was received in order to start the reproduction of the stored-type content, the reproduction of the stored-type content might not be able to be started in response to the second sync signal in case the stored-type content reproducing section is not standby for immediate start of the reproduction of the stored-type content.

However, the content reproducing device according to the present invention is arranged such that the first sync signal is received before the second sync signal in order that the stored-type content reproducing section may be standby for immediate start of the reproduction of the stored-type content.

This arrangement can shorten a lag time from the reception of the second sync signal by the content reproducing section to the actual starting of the reproduction of the stored-type content.

A broadcast system according to the present invention includes a broadcast content transmitting device for transmitting a broadcast content, and a content reproducing device for reproducing the broadcast content immediately after receiving the broadcast content. In order to attain the object, the broadcast system according to the present invention is arranged such that the broadcast content transmitting device includes: a sync signal generating section for generating sync signal(s) for causing the content reproducing device to operate in synchronism with the reproduction of the broadcast content; and a broadcast content transmitting section for transmitting the broadcast content together with the sync signal(s) multiplexed on the broadcast content, the sync signal generating section generating a sync signal that contains a control command that indicates which process to be performed by the content reproducing device in synchronism with this sync signal, the content reproducing device includes: a broadcast content receiving section for receiving the broadcast content together with sync signal(s) multiplexed on the broadcast content; a broadcast content reproducing section for reproducing the broadcast content received by the broadcast content receiving section; and a control section for controlling the content reproducing device in synchronism with the reproduction of the broadcast content in accordance with at least one of the sync signal(s), and when the broadcast content receiving section receives the sync signal, the control section executing the designated process according to the control command contained in the sync signal.

This arrangement realizes a broadcast system in which the broadcast content transmitting device broadcasts the broadcast content together with the sync signal by transmitting the broadcast content and the sync signal in synchronism at an arbitrary timing; and the content reproducing device can synchronize, at the same timing as the transmission, the reproduced broadcast content and the stored-type content process, which is performed according to the sync signal.

With this arrangement, the process to be performed by the content reproducing device in accordance with the sync signal is designated by the control command contained in the sync signal. Therefore, with this arrangement, by controlling the time of transmitting the sync signal, the broadcast content transmitting device can control the time at which the content reproducing device carries out the process. Further, the process to be performed can be specified by the control command contained in the sync signal.

In order to attain the object, a broadcast system according to the present invention is provided with: a broadcast content transmitting device for transmitting a broadcast content; a content reproducing device for reproducing the broadcast content immediately after receiving the broadcast content; and a control data providing device for providing control data to the content reproducing device. The broadcast content transmitting device includes: a sync signal generating section for generating sync signal(s) for causing the content reproducing device to operate in synchronism with the reproduction of the broadcast content; and a broadcast content transmitting section for transmitting the broadcast content together with the sync signal(s) multiplexed on the broadcast content. The control data providing device includes: a control data generating section for generating control data that designates which process to be performed by the content reproducing device in synchronism with the sync signal(s) when the content reproducing device receives the broadcast content together with the sync signal(s); and a control data transmitting section for transmitting control data to the content reproducing device. The content reproducing device includes: a broadcast content receiving section for receiving the broadcast content together with sync signal(s) multiplexed on the broadcast content; a broadcast content reproducing section for reproducing the broadcast content received by the broadcast content receiving section; a control section for controlling the content reproducing device in synchronism with the reproduction of the broadcast content in accordance with at least one of the sync signal(s); and a control data acquiring section for acquiring the control data from the control data providing device. When the broadcast content receiving section receives the sync signal, the control section executes the designated process according to the control command contained in the sync signal.

With this arrangement, the control data designates the process to be performed by the content reproducing device when the content reproducing device receives the sync signal. Therefore, according to this arrangement, by providing the control data to the content reproducing device, the control data providing device can designate the process to be performed by the content reproducing device in according to the sync signal.

The broadcast system may be arranged such that plural content reproducing devices receive the broadcast content and the sync signal. That is, it is possible to structures the broadcast system as a broadcast system which broadcasts the same broadcast content to a unspecified number of content reproducing devices, or as a broadcast system which broadcasts (multicasts) the same broadcast content to a specified number of content reproducing devices. In this case, even if the single control data providing device is used, it is possible to designate, by using the single content data providing device, the processes to be performed in accordance with the sync signal for each plural content reproducing device. Further, this arrangement can realize a broadcast system in which, by providing different control data to each content reproducing device, each content reproducing device can perform different processes individually in response to the same sync signal broadcast/multicast thereto.

In order to attain the object, a broadcast system according to the present invention is provided with a broadcast content transmitting device for transmitting a broadcast content; a content reproducing device for reproducing the broadcast content immediately after receiving the broadcast content; and a user attribute value providing device for providing a use attribute value to the content reproducing device. The broadcast content transmitting device includes: a sync signal generating section for generating sync signal(s) for causing the content reproducing device to operate in synchronism with the reproduction of the broadcast content; and a broadcast content transmitting section for transmitting the broadcast content together with the sync signal(s) multiplexed on the broadcast content. The content reproducing device includes: a broadcast content receiving section for receiving the broadcast content together with sync signal(s) multiplexed on the broadcast content; a broadcast content reproducing section for reproducing the broadcast content received by the broadcast content receiving section; a control section for controlling the content reproducing device in synchronism with the reproduction of the broadcast content in accordance with at least one of the sync signal(s); a user attribute value setting section for detecting user's operation and setting the user attribute values based on details of the user's operation; a user attribute value receiving section for receiving, from the user attribute value providing device, a user attribute value that the user attribute value providing device sets based on the operation information; a control data acquiring section for externally acquiring control data that designates which process to be performed by the control section in synchronism with at least one of the sync signal(s). The user attribute value providing device includes: an operation information receiving section for receiving operation information from the content reproducing device; a user attribute value setting section for setting the user attribute value based on the operation information; and a user attribute value transmitting section for transmitting the user attribute value to the content reproducing device.

With this arrangement, the user attribute value providing device acquires the operation information from the content reproducing device and sets the user attribute value based on the operation information. Then, the user attribute value thus set is transmitted to the content reproducing device by the user attribute value providing device. Therefore, the content reproducing device can acquire the user attribute value without performing the process of setting the user attribute value by itself. That is, with this arrangement, it is possible to realize a broadcast system in which the content reproducing device can perform a process according to the user attribute value without extra load thereon.

A content reproducing method according to the present invention is for use in a content reproducing device for receiving a broadcast content broadcast and reproducing the broadcast content immediately after the reception. In order to attain the object, the method according to the present invention includes: (a) receiving the broadcast content together with sync signal(s) multiplexed on the broadcast content; (b) reproducing the broadcast content immediately after the broadcast content is received in the step (a); and (c) controlling the content reproducing device in accordance with the sync signal in synchronism with the reproduction of the broadcast content (s).

The method according to the present invention includes at least: (a) receiving the broadcast content together with sync signal(s) multiplexed on the broadcast content; and (b) reproducing the broadcast content immediately after the broadcast content is received by the content receiving section. Then, a control operation of various kinds for the content reproducing device are carried out in accordance with the sync signal in synchronism with the reproduction of the broadcast content (s).

According to this arrangement, the broadcast content transmitting device broadcast the broadcast content and the sync signal by transmitting the broadcast content and the sync signal in synchronism at an arbitrary timing, and the content reproducing device can synchronize, at the same timing as the transmission, the reproduced broadcast content and the process to be performed according to the sync signal.

That is, according to this arrangement, it is possible for the content reproducing section to carry out various processes in synchronism with the broadcast content at the timing intended by the broadcast content transmitting section.

Moreover, apart from the processes regarding the stored-type content, the process to be realized under the control of the control section may be (i) starting/stopping of reproduction of sound (or melody) that signals reception of, e.g., a content, (ii) starting/stopping reproduction of an image that signals the reception of, e.g., a content, (iii) starting/stopping recording of a broadcast content, (iv) setting a volume, (v) and the like processes.

To “reproduce the broadcast content by the content reproducing device immediately after the reception of the broadcast content” is to reproduce the broadcast content immediately after the reception thereof, i.e., without storing the stored broadcast content in a hard disc or the like. Note that, storing the broadcast content temporally in a buffer memory is excluded from this “storing”.

The broadcasting encompasses (a) wireless broadcasting such as analog terrestrial broadcasting, digital terrestrial broadcasting, satellite broadcasting (such as BS broadcasting), and the like broadcasting, in which electromagnetic waves are utilized, (b) cable broadcasting such as cable television and the like, (c) broadcasting service by which a stream of broadcast content is distributed via a network such as the Internet.

In order to attain the object, a broadcast content transmitting method includes: (a) generating a sync signal for causing a content reproducing device to operate in synchronism with reproduction of the broadcast content, the content reproducing device reproducing a broadcast content immediately after receiving the broadcast content; and (b) transmitting the sync signal together with the broadcast content on which the sync signal(s) are multiplexed, the sync signal(s) being generated in the step (a).

In this arrangement, the sync signal is generated by the step (a). Then, by the step (b), the sync signal is transmitted together with the broadcast content on which the sync signal is multiplexed. The sync signal is used for causing the content reproducing device to operate in synchronism with the reproduction of the broadcast content.

According to this arrangement, the content reproducing device receives the broadcast content and the sync signal, which are transmitted thereto in synchronism at an arbitrary timing, and reproduces the broadcast content immediately after the reception of the broadcast content. With this arrangement, the content reproducing device can synchronize, at the same timing as the transmission, the reproduced broadcast content and the process that is to be performed according to the sync signal.

The broadcasting encompasses (a) wireless broadcasting such as analog terrestrial broadcasting, digital terrestrial broadcasting, satellite broadcasting (such as BS broadcasting), and the like broadcasting, in which electromagnetic waves are utilized, (b) cable broadcasting such as cable television and the like, (c) broadcasting service by which a stream of broadcast content is distributed via a network such as the Internet.

The scope of the present invention also includes the followings: a program for causing a computer to function of the sections of the content reproducing device according to the present invention, a program for causing a computer to function of the sections of the broadcast content transmitting device according to the present invention, a program for causing a computer to function of the sections of the control data providing device according to the present invention, a program for causing a computer to function of the sections of the user attribute value providing device according to the present invention, and computer-readable storage media respectively storing these programs therein.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram schematically illustrating an arrangement of a content reproducing device, thereby illustrating one embodiment of the present invention.

FIG. 2 is a block diagram schematically illustrating an arrangement of a broadcast system, thereby illustrating the embodiment of the present invention.

FIG. 3 is an explanatory view illustrating time schedule of broadcasting of the broadcast contents and sync signals, and reproduction of the broadcast contents and stored-type contents, thereby illustrating the embodiment of the present invention.

FIGS. 4(a) and 4(b) are schematic data structure views illustrating data structures of the control data, thereby illustrating the embodiment of the present invention.

FIG. 5 is a flowchart illustrating a flow of a process regarding the stored-type content, thereby illustrating the embodiment of the present invention.

FIG. 6 is flowchart illustrating completion of reproduction of a stored-type content, thereby illustrating the embodiment of the present invention.

FIG. 7 is a flowchart illustrating another completion of reproduction of a stored-type content, thereby illustrating the embodiment of the present invention.

FIG. 8 is an explanatory view illustrating time schedule of broadcasting of the broadcast contents and sync signals, and reproduction of the broadcast contents and stored-type contents, thereby illustrating the embodiment of the present invention.

FIGS. 9(a) and 9(b) are schematic data structure views illustrating data structures of the control data, thereby illustrating the embodiment of the present invention.

FIG. 10 is an explanatory view illustrating time schedule of broadcasting of the broadcast contents and sync signals, and reproduction of the broadcast contents and stored-type contents, thereby illustrating the embodiment of the present invention.

FIGS. 11(a) and 11(b) are schematic data structure views illustrating data structures of the control data, thereby illustrating the embodiment of the present invention.

FIG. 12 is an explanatory view illustrating time schedule of broadcasting of the broadcast contents and sync signals, and reproduction of the broadcast contents and stored-type contents, thereby illustrating the embodiment of the present invention by explaining the reproduction of with a CM content inserted by way of example.

FIG. 13 is an explanatory view explaining control of switching the channels according to sync signals, thereby illustrating the embodiment of the present invention.

FIG. 14 is an explanatory view explaining control of switching the channels according to sync signals, thereby illustrating the embodiment of the present invention.

FIG. 15 is a block diagram schematically illustrating an arrangement of a content reproducing device, thereby illustrating another embodiment of the present invention.

FIG. 16 is a schematic data structure view illustrating a data structure of the control data, thereby illustrating the another embodiment of the present invention.

FIG. 17 is a flowchart illustrating how to set a user attribute value according to user's operation history, thereby illustrating the another embodiment of the present invention.

FIG. 18 is a block diagram schematically illustrating an arrangement of a content reproducing device, thereby illustrating the another embodiment of the present invention.

FIG. 19 is a flowchart illustrating how to set a user attribute value based on user's operation, thereby illustrating the another embodiment of the present invention.

FIG. 20 is a block diagram schematically illustrating arrangements of a content reproducing device and a server device, thereby illustrating the another embodiment of the present invention.

### DESCRIPTION OF THE EMBODIMENTS

### First Embodiment

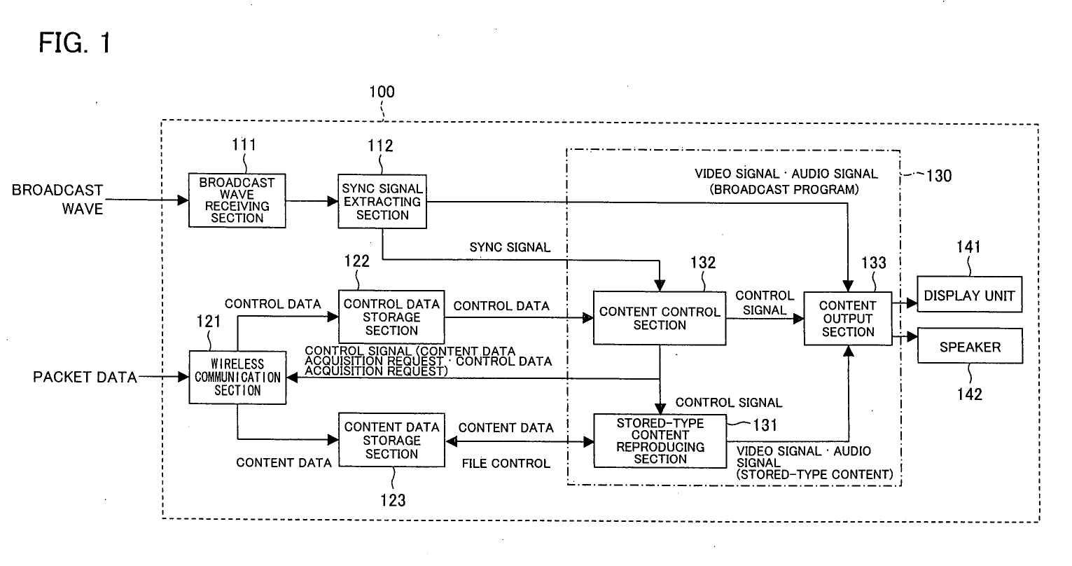

One embodiment of the present invention is described below, referring to FIGS. 1 to 14.

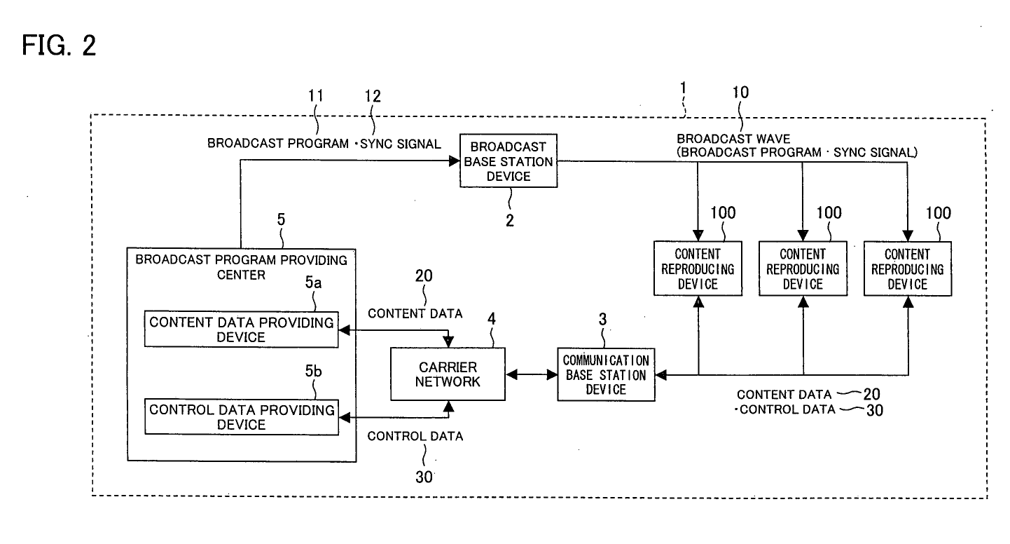

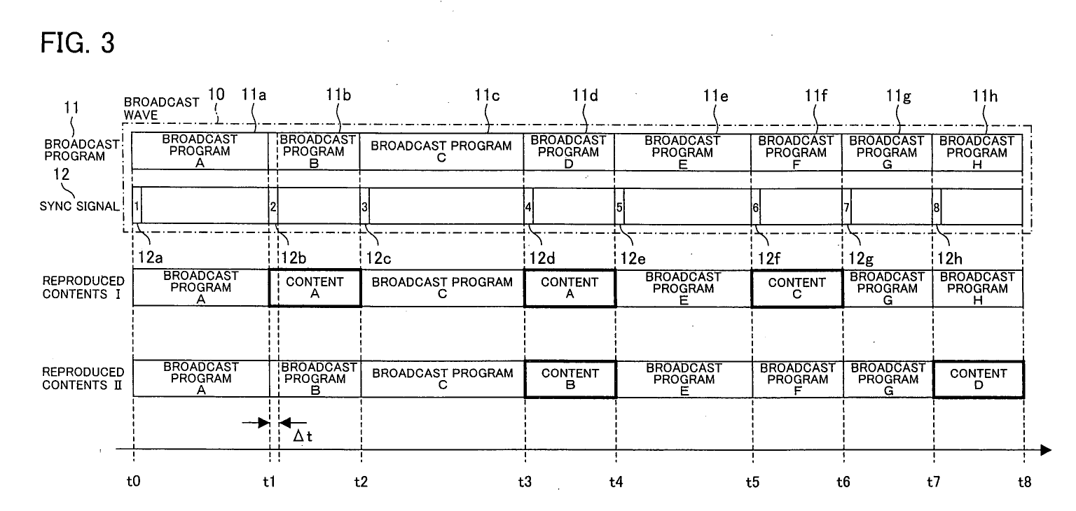

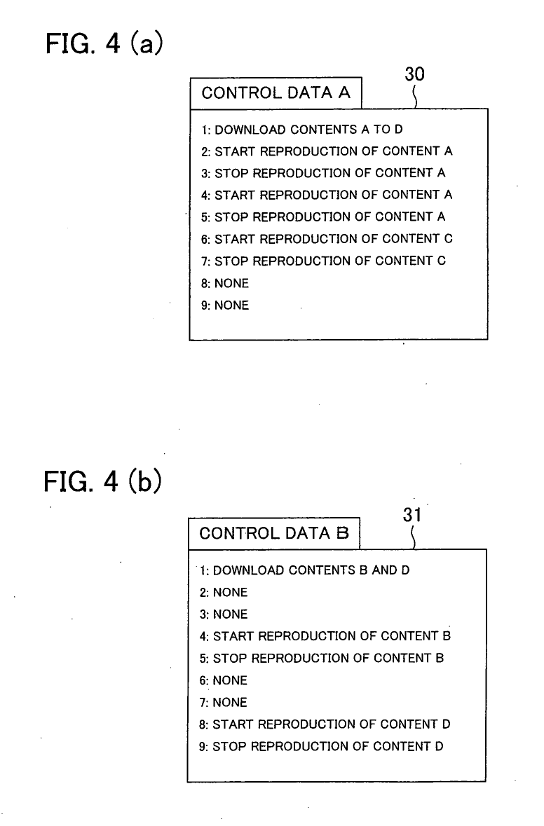

To begin with, a broadcast system 1 according to the present embodiment is described, referring to FIGS. 2 to 4. FIG. 2 is a block diagram schematically illustrating an arrangement of the broadcast system 1. FIG. 3 is an explanatory view illustrating time schedule of broadcasting of the broadcast contents and sync signals, and reproduction of the broadcast contents and stored-type contents. FIGS. 4(a) and 4(b) are schematic data structure diagram that schematically illustrates a data structure of control data used in the broadcast system 1.

(Arrangement of Broadcast System)

Firstly, the arrangement of the broadcast system 1 according to the present embodiment is described briefly. As illustrated in FIG. 2, the broadcast system 1 is provided with a broadcast base station device 2 (broadcast content transmitting means), a communication base station device(s) 3, a carrier network 4, a broadcast program providing center 5 (sync signal generating means), and a content reproducing devices 100.

The broadcast program providing center 5 is configured to generate a broadcast program (i.e., broadcast content) 11, and a synchronization (sync) signal 12 that is for causing the content reproducing device to operate in synchronism with the broadcast program 11. The broadcast program providing center 5 provides the broadcast program 11 and the sync signal 12 to the broadcast base station device 2. The broadcast base station device 2 broadcasts a broadcast wave 10 in which the sync signal 12 is multiplexed on the broadcast program 11. A content reproducing device(s) 100 receives the broadcast wave 10 from the broadcast base station device 2 and demodulates the broadcast wave 10, thereby obtaining the broadcast program 11 and the sync signal 12.

The broadcast program providing center 5 is provided with a content data providing device 5a and a control data providing device 5b (control data providing means). The content data providing device 5a and the control data providing device 5b are connected with the communication base station device(s) 3 via the carrier network 4. The content data providing device 5a and the control data providing device 5b perform wireless data communication with a content reproducing device(s) 100 located within a service area(s) of the communication base station(s) 3.

The content reproducing device 100 transmits a content data acquisition request to the content data providing device 5a via the communication base station device 3 and carrier network 4. The content data acquisition request is for requesting content data 20. The content data providing device 5a, which receives the content data acquisition request, transmits the requested content data 20 to the content reproducing device 100 via the carrier network 4 and the communication base station 3. The content reproducing device 100 receives and stores the content data 20 transmitted thereto from the content providing device 5a. The content reproducing device 100 can reproduce content at any time according to the content data 20 that is stored therein. Hereinafter, the content that is reproduced according to the content data stored in the content reproducing device 100 is referred to as “stored-type content”, thereby distinguishing such content from the broadcast program 11.

The content reproducing device 100 transmits a control data acquisition request to the control data providing device 5b via the communication base station device 3 and carrier network 4. The control data acquisition request is for requesting control data 30. The control data providing device 5b is provided with control data generating means (not illustrated) for generating, in response to the control data acquisition request, control data for designating, to the content reproducing device 100, a process to be performed in synchronism with the sync signal 12. Then, the control data providing device 5b transmits the control data 30 (which is generated by the control data providing means) to the content reproducing device 100 via the carrier network 4 and the communication base station 3. The control reproducing device 100 receives and stores the control data 30 transmitted thereto from the control data providing device 5b.

The broadcast wave 10, which the broadcast base station device 2 broadcasts, contains the broadcast program 11 and the sync signal 12. The broadcast programs 11a to 11h, each of which is a broadcast program 11, are arbitrarily scheduled by the broadcast program providing center 5. The broadcast base station device 2 broadcasts orderly the broadcast programs 11a to 11h from a broadcast start time t0 to a broadcast finish time t8 according to the schedule the broadcast program providing center 5 made.

Moreover, as illustrated in FIG. 3, the broadcast wave 10 contains the sync signal 12, which is multiplexed on the broadcast program 11. The broadcast content providing center 5 can transmit the sync signal 12 from the broadcast base station device 2 at any time. As illustrated in FIG. 3, the broadcast base station device 2 transmits a corresponding sync signal (sync signal 12a to 12h), for example, when the broadcast program (broadcast program 11a to 11h) to be broadcast is switched over. More specifically, for example, in case where the broadcast program 11b is scheduled to be broadcast after the broadcast program 11a, the broadcast base station device 2 transmits the sync signal 12a for a predetermined time period Δt from a point of time t1 from which broadcast of the broadcast program 11b starts.

The sync signals 12a to 12h are labeled with identification (ID) numbers sequentially in the order of the broadcast start times from the broadcast start time t0. The content reproducing device 100 can identify the sync signals 12a to 12h by referring to their ID numbers.

On the other hand, the control data 30 provided by the control data providing device 5b is data for designating a process to be performed by the content reproducing device 100, especially, the control section 130 in synchronism with the sync signal 12. For example, the control data 30 may be data for relating (a) the sync signal 12 that the content reproducing device 100 acquires with (b) a process that the content reproducing device 100 carries out. FIG. 4(a) illustrates an example of the structure of the control data. As illustrated in FIG. 4(a), the control data 30 defines the association of the processes to be performed with the sync signals 12a to 12h identified with the ID numbers 1 to 8. The sync signals 12a to 12h are sequentially received. As illustrated in FIG. 4(a), the processes associated with the sync signals 12a to 12h by the control data 30 encompass, process of acquiring content data, process of starting reproduction of content data, process of stopping reproduction of content data, etc. The content reproducing device 100 performs these processes respectively associated with the sync signals 12a to 12h upon receiving the corresponding sync signals.

As illustrated in FIG. 4(a), in the control data 30 process of acquiring (downloading process) of content data A to D is associated with the sync signal 12a labeled with the ID number 1. Moreover, reproduction process of reproducing content A according to content data A is associated with the sync signal 12b labeled with the ID number 2. Therefore, in case where the content reproduction device 100 holds the control data 30, the content reproduction device 100 performs the process of acquiring the content data A to D upon receiving the sync signal 12a labeled with the ID number 1, and performs the process of starting the reproduction of the content A upon receiving the sync signal 12b labeled with the ID number 2. Processes respectively associated with the sync signals 12c to 12h respectively labeled with the ID numbers 3 to 8 are performed by the content reproducing device 100 likewise upon receiving the sync signals 12c to 12h corresponding thereto.

Assume that in FIG. 3, the content A is to be reproduced by the content reproducing device 100, which holds the control data 30. From time t0 to t1, the content reproducing device 100, which holds the control data 30, reproduces the broadcast program A contained in the broadcast wave immediately (i.e., without delay) after the reception of the broadcast program A. From time t1 to t2, the content A, which is a stored-type content, is reproduced by the content reproducing device 100, as illustrated in FIG. 3. The content reproducing device 100 performs reproduction processes for the time t2 to t8 likewise as illustrated in FIG. 3.

As described above, the control data 30 relates the sync signals 12a to 12h with the processes to be processed by the content reproducing device 100 upon receiving the sync signals 12a to 12h. Therefore, by supplying the content reproducing device 100 with another control data (control data 31), it is possible to cause the content reproducing device 100 to perform different processes upon receiving the same sync signals 12a to 12h. FIG. 4(b) illustrated an example of another control data 31 different from the control data 30 that is illustrated in FIG. 4(a). In FIG. 4(b), the content B is a content to be reproduced by the content reproducing device 100, which holds the control data 31.

The broadcast program providing center 5 can provide different pieces of control data independently to the plurality of content reproducing devices 100 illustrated in FIG. 2. With this arrangement, it is possible to cause each content reproducing devices 100 to perform different processes independently even if the same broadcast wave is multicast to the content reproducing devices 100. In this case, it is preferable that the control data acquisition request that the content reproducing device 100 transmits contains an ID that specifies the content reproducing device 100 that transmits it. Meanwhile, it is preferable that the control data providing device 5b detect the ID contained in the control data acquisition request, and transmit control data that corresponds to the ID. With this arrangement, the broadcast program providing center 5 can provide, to the respective content reproducing devices 100, the stored-type content that is to be reproduced in replacement of part of the broadcast programs 11 and that is suitable for the content reproducing device 100.

(Arrangement of Content Reproducing Device)

Next, an arrangement of the content reproducing device 100 provided in the broadcast system 1 is described referring to FIG. 1. FIG. 1 is a block diagram illustrating the arrangement of the content reproducing device 100. The content reproducing device 100 is, for example, a portable telephone terminal capable of reproducing the broadcast content and stored-type content. The following is an example of the arrangement of the content reproducing device 100.

As illustrating in FIG. 1, the content reproducing device 100 is provided with a broadcast wave receiving section 111 (broadcast content receiving means), a sync signal extracting section 112 (broadcast content reproducing means), a wireless communication section 121 (control data acquiring means), a control data storage section 122, a content data storage section 123 (content storage section), and a control section 130 (control means).

The broadcast wave receiving section 111 receives the broadcast wave transmitted thereto from the broadcast base station device 2, and demodulates the signal that corresponds to a channel that the user selects. The demodulated signal is sent to the sync signal extracting section 112 from the broadcast wave receiving section 111.

The sync signal extracting section 112 extracts the sync signal out of the signal that the sync signal extracting section 112 acquires from the broadcast wave receiving section 111. The extracted sync signal is sent to a content control section 132 from the sync signal extracting section 112. On the other hand, a video signal and an audio signal contained in the signal acquired from the broadcast wave receiving section 111 are sent from the sync signal extracting section 112 to a content output section 133, which will be described later. Note that the video signal and the audio signal may be referred to as “broadcast program” later where such expression will not cause any confusion, because the video signal and the audio signal outputted from the sync signal extracting section 112 are signals that represent the broadcast program. It should be noted that the present invention is not limited to the present embodiment in which the broadcast content reproducing means for reproducing a broadcast program (broadcast content) is realized as the sync signal extracting means 121 for extracting a video signal and an audio signal (which represents the broadcast content) from the broadcast wave 10. The broadcast content reproducing means of the present invention is not particularly limited, provided that it is a means for obtaining at least one of the video signal and audio signal out of the broadcast wave, and outputting the at least one of the video signal and audio signal immediately after the reception of the broadcast wave. Here, what is meant by the term “to reproduce” is to convert a signal in a transmission format into a signal(s) which is for use in displaying or sounding. That is, this term is not used to “display” or “sound” here, even though the term “to reproduce” sometimes used to means “to display/sound” as it generally means.

The wireless communication section 121 performs wireless data communication with the communication base station device 3. Specifically, the wireless communication section 121 demodulates the carrier wave transmitted thereto from the communication base station device 3, and obtains packet data superimposed on the carrier wave. The data thus obtained is sent to the content data storage section 123 if the data is content data provided in response to the content data acquisition request. Meanwhile, the data thus obtained is sent to the control data storage section 122 if the data is control data provided in response to the control data acquisition request. Moreover, the content data acquisition request, control data acquisition request, and the like from the control section 130 are transmitted to the communication base station device 3 by the wireless communication section 121 in the form of packet data superimposed on the carrier wave.

The control data storage section 122 is a storage device, such as memory or the like, that can store the control data therein. The control data storage section 122 stores therein the control data acquired via the wireless communication section 121. Moreover, the content data storage section 123 is a storage device, such as memory or the like, that can store the content data therein. The content data storage section 123 stores therein the content data acquired via the wireless communication section 121.

The content data storage section 123 may be arranged such that specific file names are given to every content data so that the plurality of content data are stored in such a manner that they can be administered with the file names. This arrangement allows the control section 130 to designate a given content data by its file name at any time so as to retrieve the given content data from the content data storage section 123. Moreover, the control data storage section 122 and the content data storage section 123 may be provided separately as illustrated in FIG. 1, or a single storage device may be provided to serve as both the control data storage section 122 and the content data storage section 123.

The control section 130 performs, according to the sync signal, at least one of storing content data in the content data storing section 123 and processing the stored content data (stored-type content data) stored in the content data storing section 123. This arrangement allows the process of the stored-type content to be performed in synchronism with the broadcast content that is reproduced immediately after (without delay) the reception of the broadcast content.

As illustrated in FIG. 1, the control section 130 is provided with, as functional blocks, a stored-type content reproducing section 131 (stored-type content reproducing means), the content control section 132 (content reproduction preparing means, content output control means), and the content output section 133 (video output means, sound output means). Each functional block of the control section 130 may be realized by way of software as executed by a CPU (Central Processing Unit).

The stored-type content reproducing section 131 reproduces (i.e., reads and processes) the content data stored in the content data storage section 123, thereby processing the content data into the video signal and audio signal that represent the stored-type content. Then, the stored-type content reproducing section 131 outputs the video signal and the audio signal to the content data output section 133. Because the video signal and the audio signal outputted from the stored-type content reproducing section 131 are signals that represent the stored-type content, the video signal and the audio signal may be referred to as “stored-type content” later sometimes where such expression will not cause confusion. The stored-type content reproducing section 131 can select and reproduce a given piece of content data from among the pieces of content data stored in the content data storage section 123. The selection of the content data by the stored-type content reproducing section 131 is controlled by the content control section 132 described later. Moreover, as long as concerned section(s) is active, the stored-type content reproducing section 131 can start the reproduction of the content data at any time, and stop the reproduction of the content data at any time. The later-described content data control section 132 controls timings at which the stored-type content reproducing section 131 starts and stops the reproduction of the content data.

The broadcast program outputted from the sync signal extracting section 112, and/or the stored-type content outputted from the stored-type content reproducing section 131 is outputted to a display unit 141 and a speaker 142 by the content output section 133. The content control section 132 controls whether the content output section 133 outputs the broadcast program, the stored-type content, or composition of both the broadcast program and the stored-type content.

The content output section 133 is capable of outputting an image of the stored-type content in replacement of part or whole of an area in which an image of the broadcast program is displayed, or an image produced by combining the image of the stored-type content with part or whole of the image of the broadcast program. More specifically, the content output section 133 can switch over the video signal to be outputted to the display unit 141, between the video signal of the broadcast program and the video signal of the stored-type content, so that only one of the video signals will be outputted to the display unit 141. Furthermore, the content output section 133 can output, to the display unit 141, a composition of the video signal of the broadcast program and the video signal of the stored-type content. For example, the content output section 133 can generate a video signal that represents a display screen picture in which a display screen picture of one of the video signal of the broadcast program and the video signal of the stored-type content is positioned in part of a display screen picture of the other. Moreover, for example, the content output section 133 can generate a video signal that represents a display screen picture in which a display screen picture of one of the video signal of the broadcast program and the video signal of the stored-type content is “on-screen displayed” (i.e., superimposed) on a display screen picture of the other.

Moreover, the content output section 133 can switch over the audio signal to be outputted to the speaker 142, between the audio signal of the broadcast program and the audio signal of the stored-type content, so that only one of the audio signals is outputted to the speaker 142. Further, the content output section 133 can output the audio signal of the stored-type content while outputting the video signal of the broadcast program to the display unit 141. The content output section 133 can also output the audio signal of the broadcast program while outputting the video signal of the stored-type content to the display unit 141.

The content control section 132 controls the wireless communication section 121, stored-type content reproducing section 131, and content output section 133 to operate in synchronism with the broadcast program reproduced immediately after the reception thereof.

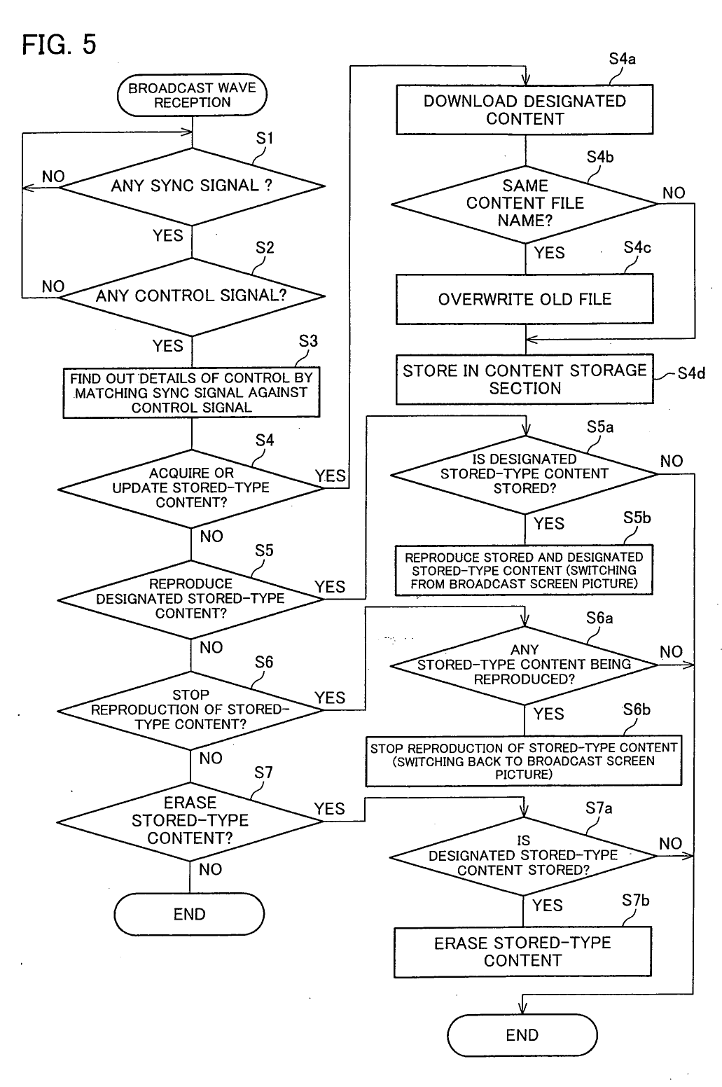

The control operation performed by the content control section 132 is described below, referring to FIGS. 5 to 7. FIG. 5 is a flowchart illustrating a flow of the control operation that the content control section 132 performs.

As illustrated in FIG. 5, the content control section 132 monitors for a sync signal continuously while the broadcast program is reproduced immediately after the reception thereof (Step S1). Upon receiving the sync signal (Step S1: Yes), the content control section 132 checks whether or not control data is stored in the control data storage section 122 (Step S2). If the control data is stored in the control data storage section 122 (Step S2: Yes), the content control section 132 performs, as described later, a process that is associated with the sync signal by the control data.

The content control section 132 can acquire the control data as described below. The content control section 132 controls the wireless communication section 121 to transmit, to the control data providing device 5b, a control data acquisition request that requests for the control data. In response to the control data acquisition request, the control data is transmitted from the control data providing device 5b to the wireless communication section 121. The control data acquired via the wireless communication section 121 is stored in the control data storage section 122.

The content control section 132 may be arranged such that the content control section 132 transmits the control data acquisition request upon activation of the content reproducing device 100, or at a specific time that is set in advance. Moreover, the control data may contain time information that specifies period of validity of the control data. In this case, the content control section 132 may be arranged such that the content control section 132 refers to the time information contained in the control data stored in the control data storage section 122, and if a current time is within the term of validity, the content control section 132 is allowed to request for new control data. The content control section 132 erases the old control data that has been stored in the control data storage section 122 after the content control section 132 receives the new control data in response to the control data acquisition request. After that, the content control section 132 causes the control data storage section 122 to store the new control data therein.

As illustrated in FIG. 5, the content control section 132 matches the sync signal acquired at S1 against the control data stored in the control data storage section 122, thereby finding out details of control operation to do (Step S3). Specifically, after receiving the sync signal from the sync signal extracting section 112, the content control section 132 controls the concerned sections to execute the process that the control data relates with the sync signal. The control data relates the processes with the sync signals. Examples of such processes are, as described above: (1) process of acquiring content data; (2) process of activating the stored-type content reproducing section 131; (3) process of starting the reproduction of the content data; (4) process of stopping the reproduction of the content data; (5) process erasing the content data; and other processes. Therefore, by performing the following steps one by one, the content control section 132 determines whether the acquired sync signal is associated with a process of acquiring content data (Step S4), a process of starting the reproduction of the content data (Step S5), (4) a process of stopping the reproduction of the content data, (Step S6), or (5) a process of erasing the content data (Step S7). Via these determination steps, the process with which the acquired sync signal is in associated is found out. The process thus found out is then carried out. The following explains the processes further.

(1) Process of Acquiring Content Data

If the acquired sync signal is in associated with the process of acquiring content data (Step S4: Yes), the content control section 133 controls the wireless communication section 121 to transmit, to the content data providing device 5a, the content data acquisition request that requests for the content data, and acquire (download) the content data therefrom (S4a). The content data transmitted from the content data providing device 5a in response to the content data acquisition request is received via the wireless communication section 121, and stored in the content data storage section 123 (S4c).

The sync signal may be associated with a process of acquiring specific content data. In this case, the content control section 133 controls the wireless communication section 121 to transmit, to the content data providing device 5a, the content data acquisition request that requests for the specific content data, and acquire (download) the specific content data therefrom (S4a). If the same content data (Old content data) as the specific data is already stored in the content data storage section, the content control section 133 overwrites and updates the same content data with the specific content data (Step S4b).

(2) Process of Starting Reproduction of Content Data

As illustrated in FIG. 5, if the acquired sync signal is in association with the process of starting the reproduction of specific content data (Step S5: Yes), the content control section 132 determines whether the specific content data is stored in the content data storage section 123. If the specific content data is stored in the content data storage section 123 (S5a: Yes), then the content control section 132 controls the stored-type content reproducing section 131 to start the reproduction of the specific content data (S5b). Then, the content control section 132 controls the content output section 133 to output, to the display unit 141 and the speaker 142, a video signal and an audio signal (stored-type content) obtained from the stored-type content reproducing section 131 (S5b). At S5b, the content output section 133 may output the video signal and audio signal (stored-type content) obtained from the stored-type content reproducing section 131, but not the video signal and audio signal (broadcast program) obtained from the sync signal extracting section 112. Furthermore, at S5b, the content output section 133 may output a composition of the video signals and audio signals (i.e., of the broadcast program and stored-type content).

If the stored-type content reproducing section 131 cannot perform the reproduction of the content data at the time when the sync signal in association with the process of starting the reproduction of the content data is acquired (S5a: No), the content control section 132 ends the process with the content output section 133 and keeps outputting the broadcast program to the display unit and speaker. With this, the broadcast program is kept outputted to the display unit and speaker, even if the stored-type content reproducing section 131 cannot reproduce the content data. For instance, the stored-type content reproducing section 131 cannot reproduce the content data when: the content data is not stored in the content data storage section 123 at the time when the sync signal in association with the process of starting the reproduction of the content data is acquired (S5a: No).

(3) Process of Stopping Reproduction of Content Data

As illustrated in FIG. 5, if the sync signal in association with the process of stopping the reproduction of the content data is acquired (Step S6: Yes), the content control section 132 determines whether the reproduction of the content data is being carried out at the moment (Step S6a). If the reproduction is being carried out (Step S6a: Yes), the content control section controls the stored-type content reproducing section 131 to stop the reproduction of the content data (S6b). At the same time, the content control section 132 stops the output of the visual signal and audio signal (stored-type content) obtained from the stored-type content reproducing section 131, and controls the content output section 133 to output only the visual signal and audio signal (broadcast program) obtained from the sync signal extracting section 112 (S6b). This arrangement realizes switching-over from the reproduction of the stored-type content to the reproduction of the broadcast program in response to the acquisition of the sync signal that is associated with the process of stopping the reproduction of the content data.

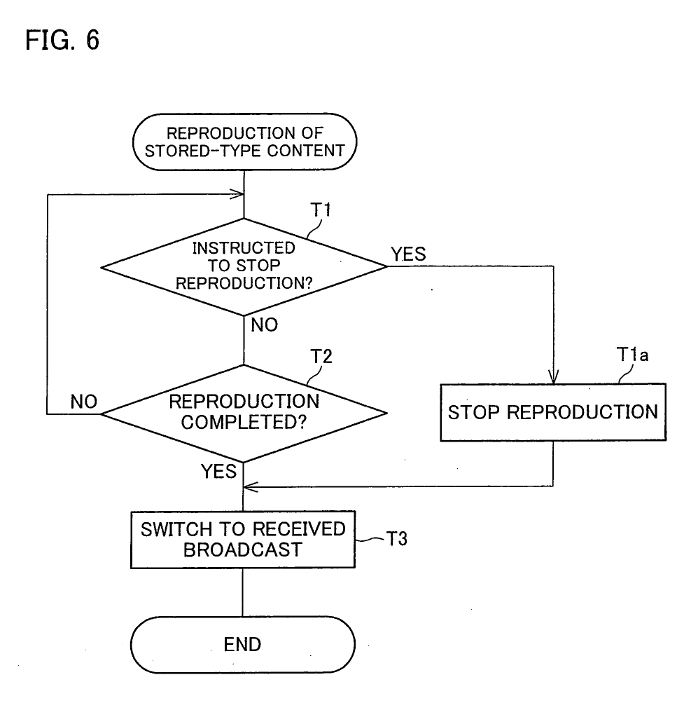

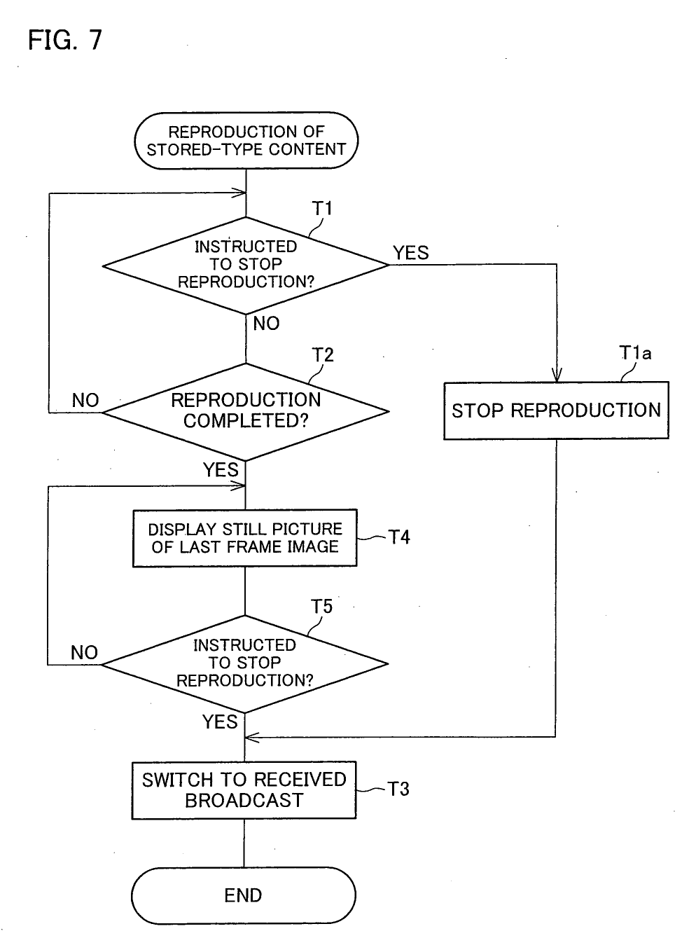

There is a case where the reproduction of the stored-type content is ended (i.e., predetermined reproduction time for reproducing the stored-type content has passed) before the acquisition of the sync signal associated with the process of stopping the reproduction of the content data. One countermeasure for this case is to perform the process of stopping the reproduction of the content data in a way as illustrated in the flowchart of FIG. 6 or 7.

(a) Process of Stopping Reproduction (FIG. 6): At the time when the reproduction of the stored-type content is finished, the output of the stored-type content is stopped and only the broadcast program is outputted.

As illustrated in FIG. 6, the content control section 132 monitors for the sync signal outputted from the sync signal extracting section 112, and executes a process (Step T2) for monitoring the stored-type reproducing section 131 in order to determine whether or not the reproduction of the stored-type content being reproduced is finished, in addition to a process (Step T1) for monitoring the sync signals outputted from the sync signal extracting section 112 in order to determine whether or not the sync signal is the sync signal that is associated with the process of stopping the reproduction of the content data. Upon detecting the sync signal associated with the process of stopping the reproduction of the content data (T1: Yes), the content control section 132 controls the content reproducing section 131 to stop the reproduction of the content data (T1a). Further, if the reproduction of the stored-type content is finished (T2: Yes) or after the process of stopping the reproduction (T1a) of the content is completed, the content control section 132 controls the content output section 133 to switch the content output from outputting the stored-type content to outputting the broadcast program. (Step T3). According to the process of stopping the reproduction illustrated in FIG. 6, the video signal and the audio signal to be outputted respectively to the display unit and speaker are automatically switched over after the predetermined reproduction time is passed and the reproduction of the stored-type content is completed.

(b) Process of Stopping Reproduction (FIG. 7): After the reproduction of the stored-type content is completed, the output of the video signal contained in the stored-type content is continued to display a still image.

As illustrated in FIG. 7, if the reproduction of the stored-type content is completed (T2: Yes), the content control section 132 controls the stored-type content reproducing section 131 to continue the output of the video signal contained in the stored-type content whose reproduction is completed (e.g., a video signal that represents a last frame image of the stored-type content) in order to display a still image of the video signal (e.g., the last frame) (Step T4). Then, while the stored-type content reproducing section 131 is outputting the still image, the content control section 131 waits for the sync signal that is in association with the process of stopping the reproduction of the content data (Step T5). If the content control section detects the sync signal that is in association with the process of stopping the reproduction of the content data (T5: Yes), then the content control section 131 controls the content output section 133 to stop the output of the stored-type content and output only the broadcast program (Step T3). According to the process of stopping the reproduction as illustrated in FIG. 7, the content output section 133 keeps outputting, to the display unit, the image of the stored-type content (which has been outputted) as a still image, until the content control section 132 acquires the sync signal associated with the process of stopping the reproduction of the content data.

That is, according to the process of stopping the reproduction illustrated in FIG. 6 or 7, it is possible to keep supplying the video signal to the display unit continuously even if the reproduction of the stored-type content is finished before the acquisition of the sync signal associated with the process of stopping the reproduction of the content data.

(4) Process of Erasing Content Data

As illustrated in FIG. 5, if the sync signal associated with the process of erasing the content data is acquired (Step S7: Yes), the content control section 132 erases the stored-type content stored in the content data storage section 123 (Step S7b). If the content control section 132 receives the sync signal associated with the process of erasing specific content data, then the content control section 132 determines whether the specific content data is stored in the content data storing section 123 (Step S7a). If the specific content data is stored in the content data storing section 123 (Step S7a: Yes), the content control section 132 erases the specific stored-type content (Step S7b).

(Process of Activating Content Reproducing Section 131)

One object of the content reproducing device 100 is to attain such reproduction of the stored-type content that the stored-type content is reproduced at an exact timing with respect to the reproduction of the broadcast program (i.e., with respect to the broadcast content that is reproduced immediately after the reception thereof), so that this reproduction will be carried out without giving the user a sense of strangeness when switching over from/to the broadcast program to/from the stored-type content. Thus, it is preferable to arrange such that the stored-type content reproducing section 131 be activated before the start of the reproduction of the stored-type content, so that the stored-type content reproducing section 131 will be standby and the reproduction of the stored-type content can start without delay. In the “standby” condition, the stored-type content reproducing section 131 can start the reproduction of the stored-type content immediately.

Therefore, it is preferable that before transmitting the sync signal (first sync signal) associated with the reproduction start process of the content data, the broadcast base station device 2 transmit the sync signal (second sync signal) associated with the process of activating the stored-type content reproducing section 131. (note that the terms “first” and “second” (and “third” later) are used simply for references of the sync signals for easy explanation, and should not be regarded as words to mean any order). Further, it is preferable that the content control section 133 of the content reproducing device 100 activate the stored-type content reproducing section 131 upon acquisition of the sync signal associated with the process of activating the stored-type content reproducing section 131. The activation of the stored-type content reproducing section 131 is to start execution of a stored-type content reproduction program which causes the content reproducing device 100 to function as the stored-type content reproducing section 131. With this, the stored-type content reproducing section 131 thus activated can immediately start the reproduction of the stored-type content in response to the acquired sync signal at any time. As to time intervals between (a) the transmission of the sync signal associated with the process of activating the stored-type content reproducing section 131 and (b) the transmission of the sync signal associated with the process of starting the reproduction of the content data, the time intervals may be set in any ways depending on performance etc. of the content reproducing device 100. For example, the time interval may be set as, 10 seconds, 1 second, or 0.1 second.

(Modification 1)

The present invention is not limited to the above arrangement in which the processes to be performed by the content reproducing device 100 is associated with the respective sync signals and the process to be performed by the content reproducing device 100 is determined by reference to the control data and performed in synchronism with the sync signal.

In this modification of the broadcast system 1, the process to be performed by the content reproducing device 100 is determined by reference to control number (process designating information) contained in the sync signal.

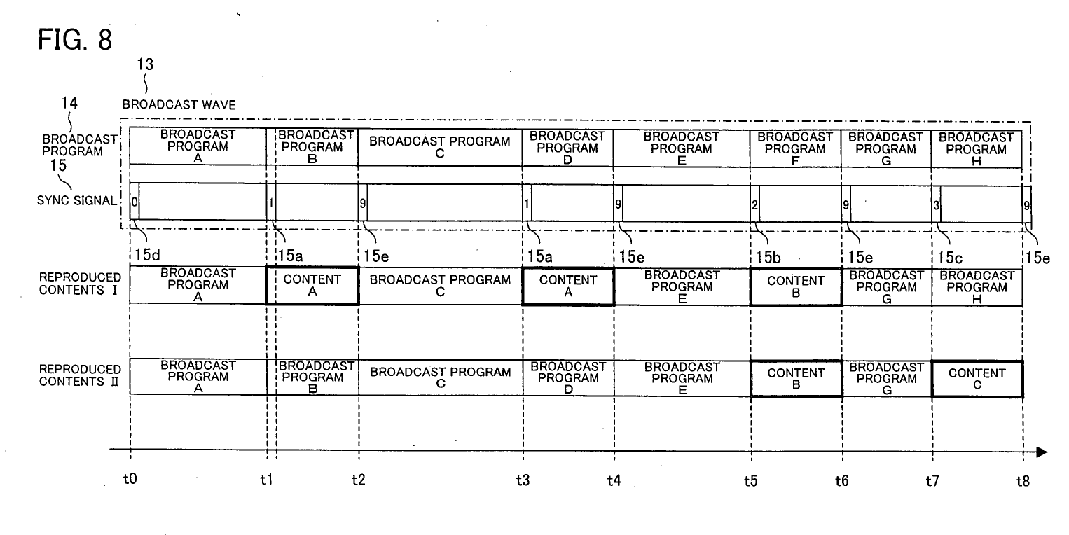

As illustrated in FIG. 8, a broadcast wave 13 in the present modification contains broadcast programs 14 and sync signals 15a to 15e. The sync signals 15a to 15e respectively contain control number 0 to 3, or 9. The control numbers are to specify the processes to be processed by a content reproducing device 100. But control data 32 associates the control numbers and the processes to be processed by the content reproducing device 100.

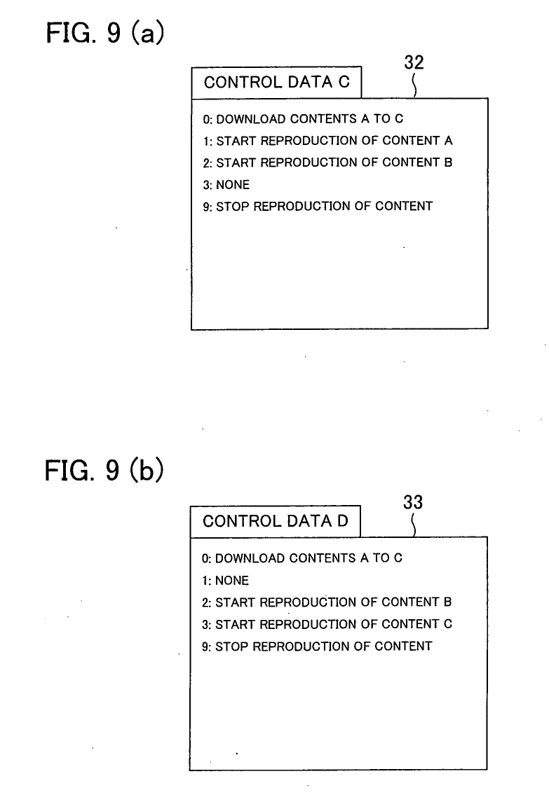

Meanwhile, as illustrated in FIG. 9(a), control data 32 relates the processes to be performed respectively with the sync signals 15a to 15e labeled with the control numbers respectively. For example, control data illustrated in FIG. 9(a) relates the processes to be performed, with the sync signals 15a to 15e labeled with the control numbers respectively such that: the process of downloading the contents A to D is performed when the sync signal 15d labeled with control number 0 is acquired; the process of starting the reproduction of content A is performed when the sync signal 15a labeled with control number 1 is acquired; the process of starting the reproduction of content B is performed when the sync signal 15b labeled with control number 2 is acquired; any process is not performed when the sync signal 15c labeled with control number 3 is acquired; and the process of stopping the reproduction of the content is performed when the sync signal 15e labeled with control number 9 is acquired. On the other hand, the control data 33 illustrated in FIG. 9(b) relates the processes to be performed respectively with the sync signals 15a to 15e labeled with the control numbers such that: the process of downloading the contents A to D is performed when the sync signal 15d labeled with control number 0 is acquired; any process is not performed when the sync signal 15a labeled with control number 1 is acquired; the process of starting the reproduction of the content B is performed when the sync signal 15b labeled with control number 2 is acquired; the process of reproducing the content C when the sync signal 15c labeled with control number 3 is acquired; and the process of stopping the reproduction of the content is performed when the sync signal 15e labeled with control number 9 is acquired.

By arranging the control data 32 and the sync signals 15 as above, a broadcast program providing center 5 can instruct, by using the sync signals 15a to 15e, a content reproducing device 100 as to which process to perform. In addition, the broadcast program providing center 5 can give different instructions to the content reproducing devices individually as to the processes to perform. For example, each individual content reproducing device 100 can be individually specified by the control data 32 as to which process to perform or not to perform, and by changing the control data to be provided to the content reproducing device 100, the broadcast program providing center 5 can control which process the content reproducing device 100 performs or does not perform.

(Modification 2)

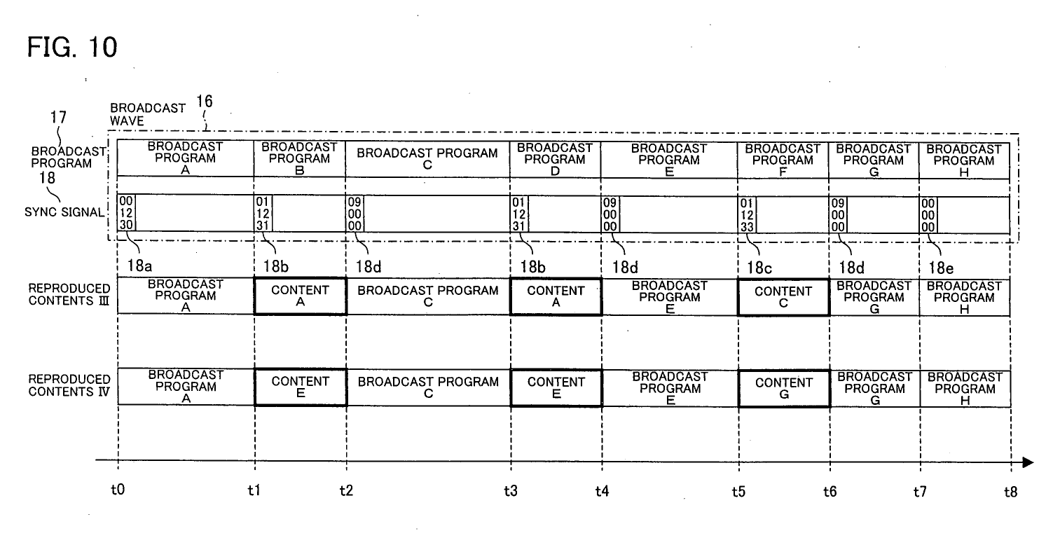

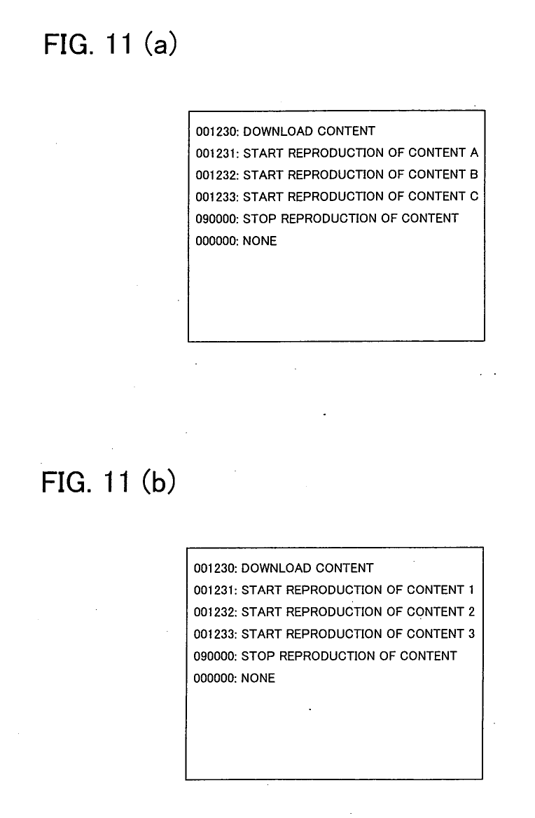

Another modification of the broadcast system 1 is described here referring to FIGS. 10 and 11. In the present modification, the process to be performed by the content reproducing device 100 is determined based on a control command contained in the sync signal.

As illustrated in FIG. 10, the broadcast wave 16 in the present modification contains broadcast programs 17 and sync signals 18a to 18e. The sync signals 18a to 18e respectively contain control commands such as “001230”, “001231” and the like. The control commands relate in advance the sync signals 18a to 18e with processes to be performed by the content reproducing device 100. In the present modification, therefore it is not necessary to use the control data described above for causing the content reproducing device 100 by the sync signal to perform a specific process.

FIGS. 11(a) and 11(b) illustrate examples of tables that relate the sync signals 18a to 18e in the present modification with the processes to be performed by the content reproducing device 100. As illustrated in FIG. 11(a), the table 40 relates the sync signal 18a (contains the control command “001230”) with a process of downloading a stored-type content. Moreover, the table 40 relates the sync signal 18b (containing the control command “001231”) with a process of starting reproduction of content A. The other sync signals are related to specific processes likewise.

In order to practice the present modification, the content reproducing device 100 and a broadcast program providing center 5 as illustrated in FIG. 2 use the same table 40 that relates the sync signals 18a to 18e with the processes to be performed by the content reproducing device 100. That is, the content reproducing device 100 is provided with storage means (not illustrated) such as a ROM (Read Only Memory) or the like, for fixedly storing the table 40 that relates the sync signals 18a to 18e with the processes to be performed by the content reproducing device 100, whereas the broadcast program providing center 5, which supplies the sync signals to the content reproducing device 100, is provided with storage means for fixedly storing the same table 40. With this, the broadcast content providing center 5 can cause the content reproducing device 100 to perform an intended process at an intended timing. In FIG. 10, the content E is a content to be reproduced in response to the sync signals 18a to 18e by the content reproducing device 100 that holds the table 40.

Note that the stored-type content to be reproduced by the content reproducing device 100 is not ambiguously determined even if the association with the sync signals 18a to 18e and the processes to be performed by the content reproducing device 100 is preset. That is, for example, in a case where a table 41 as illustrated in FIG. 11(b) is shared between the content reproducing device 100 and the broadcast program providing center 5, the reproductions based on the respective content data are performed by the content reproducing device 100 in the order of the content data in a content data storage section 123 (that is, “first stored, first reproduced”) In the table 41 in FIG. 11(b), the sync signal 18b containing the control command “001231” is related to a process of starting reproduction of the content 1, that is, the first content among the content data stored in the content data storage section 123. Meanwhile, a sync signal 18 containing the control command “001232” is related to a process of starting reproduction of the content 2, that is, the second content among the content data stored in the content data storage section 123. Note that the order of the content data stored in the content data storage section 123 may be an order defined by date and time when the content data are stored in the content data storage section 123, or an order determined according to file names of the content data. In FIG. 10, the content F is a content that is to be reproduced in response to the sync signals 18a to 18e by the content reproducing device 100 that holds the table 41. Here, it is assumed that the content data storage section 123 stores therein the content data E, F, G, H, . . . in this order. If the content reproducing device 100 stores the content data in a different order, the content data are reproduced in the different order.

(Remarks)

The present embodiment is explained only referring only to the processes regarding the stored-type content as the process realized under control of the control section 130. However, the present invention is not limited to this. That is, the content reproducing device 100 can carry out not only the processes regarding the stored-type content but also various processes in accordance with the sync signal in synchronism with the reproduction of the broadcast content received by the broadcast wave receiving section 111. Apart from the processes regarding the stored-type content, the process to be realized under the control of the control section may be (i) starting/stopping of reproduction of sound (or melody) that signals reception of, e.g., a content, (ii) starting/stopping reproduction of an image that signals the reception of, e.g., a content, (iii) starting/stopping recording of a broadcast content, (iv) setting a volume, (v) and the like processes.

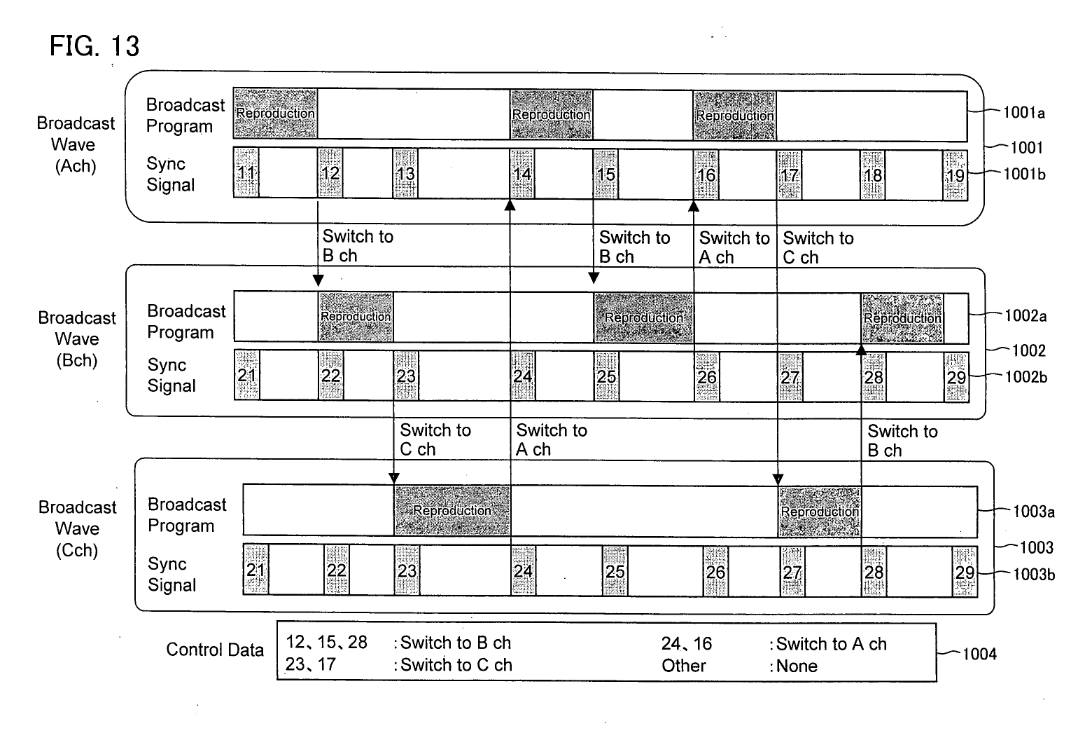

Referring to FIG. 13, switching the reception channels according to the sync signal is explained below as an example of such processes. As illustrated in FIG. 13, it is supposed that A ch broadcast wave 1001, B ch broadcast wave 1002, and C ch broadcast wave 1002 are broadcast at the same time. The broadcast waves 1001 to 1003 respectively contain the broadcast contents 1001 to 1003a and sync signals 1001 to 1003b multiplexed thereon. The control data 1004 is an example of control data to be acquired by the content reproducing device 100 for switching the reception channels according to the sync signals.

For example, suppose the content reproducing device 100 acquires a sync signal having a control number “12” while receiving in A ch broadcast wave 1001. Then, the content reproducing device 100 refers to the control data 1004 to find out which process to be processes. The control data 1004 associates the control number “12” with switching to B ch. Thus, the control section 130 of the content reproducing device 100 switches the reception channel to receive B ch broadcast wave 1002.

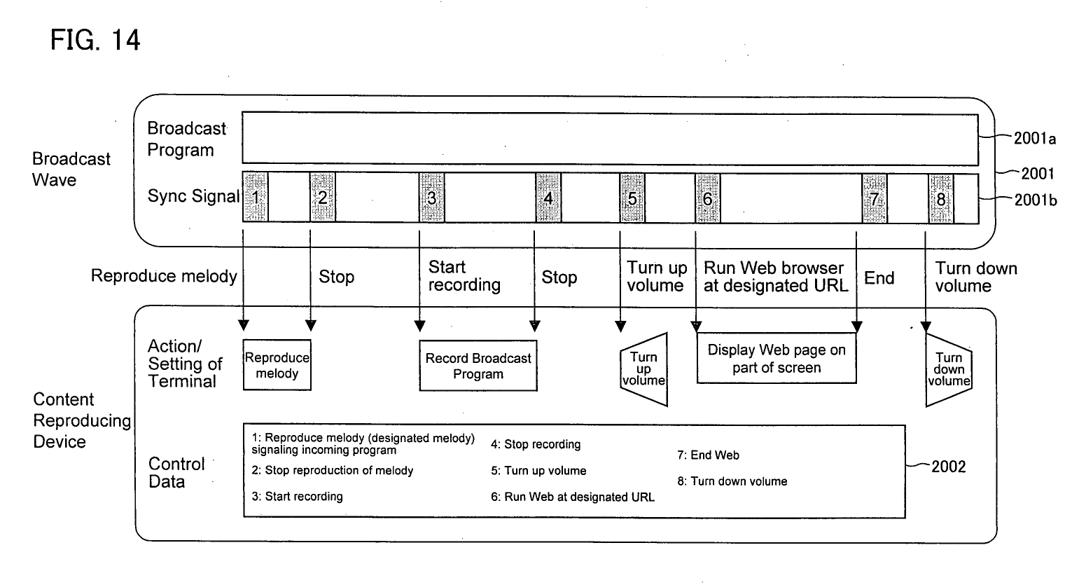

Moreover, FIG. 14 is an explanation view explaining the cases to perform the processes of starting/stopping the production of melody that signals the reception, starting/stopping recording the broadcast content, controlling volume, and starting/stopping displaying a Web page. For example, the control data 2002 acquired by the content reproducing device 100 designates such that the process of starting the production of melody that signals the reception is the process to be performed when the sync signal containing the control number “1” is received. When acquiring the sync signal having the control number 1, the content reproducing device 100 refers to the control data 2002 thereby to find out the process to perform. As for the control number “1”, the control data 2002 designate the process of starting the reproduction of the melody that signals the reception. Thus, the control section 130 of the content reproducing device 100 starts the reproduction of the melody that signals the reception.

### Second Embodiment

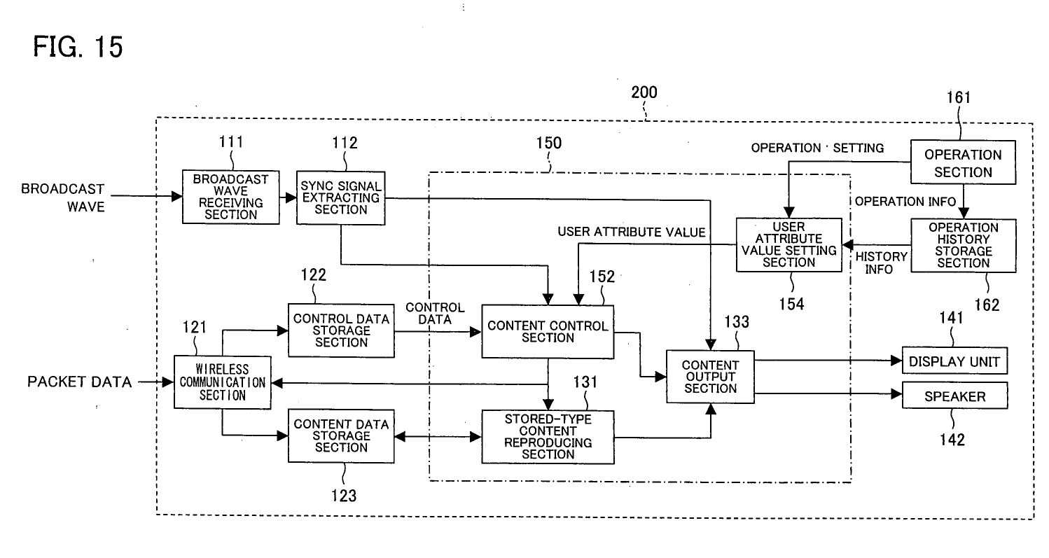

A second content reproducing device 200 is modified from the content reproducing device 100 of the first embodiment to perform different processes according the sync signal by reference to user attribute. FIGS. 15 to 19 explain the content reproducing device 200 having the function of performing different processes according the sync signal by reference to user attribute.

As illustrated in FIG. 15, the content reproducing device 200 is provided with a broadcast wave receiving section 111, a sync signal extracting section 112, a wireless communication section 121, a control data storage section 122, and a content data storage section 123. These blocks of the content reproducing device 200 have like function as the corresponding blocks of the content reproducing device 100. Thus, they are labeled in the same manner and their explanation is omitted here.

The content reproducing device illustrated in FIG. 15 is different from the content reproducing device 100 illustrated in FIG. 1 in that the content reproducing device 200 is further provided with an operation section 161 and an operation history storage section 162, and a control section 150 provided with a user-attribute setting section 154.

The operation section 161 is an interface for allowing an user to input an operation in the content reproducing device 200. That is, the operation section 161 receives the user's operation and forwards, to the operation history storage section 162, operation information regarding details of the user's operation performed by the user. The operation history storage section 162 is a storage device capable of accumulating the operation information. For example, a memory can be employed as the operation history storage section 162. The operation information accumulated in the operation history storage section 162 is referred to as “operation history” hereinafter. The operation history is referred to by the user attribute value setting section 154 at any times.

The control section 150 of the content reproducing device 200 is provided with a stored-type content reproducing section 131, a content control section 152, a content output section 133, and the user attribute value determining section 154. The stored-type content reproducing section 131 and the content output section 133 have like functions as the corresponding blocks of the content reproducing section 100 illustrated in FIG. 1. Thus, they are labeled likewise and their explanation is omitted here.

The user attribute value setting section 154 determines (sets) a user attribute value according to operation history of the user stored in the operation history storage section 162. The user attribute value thus set is looked up by the content control section 152. The present invention may be arranged such that the user attribute value thus set by the user attribute value determining section 154 is stored in storage means (not illustrated), so that the user attribute value will be retrieved therefrom in response to an acquisition request from the content control section 152. Furthermore, the present invention may be arranged such that the user attribute value is set directly by the user via operating the operation section 161.

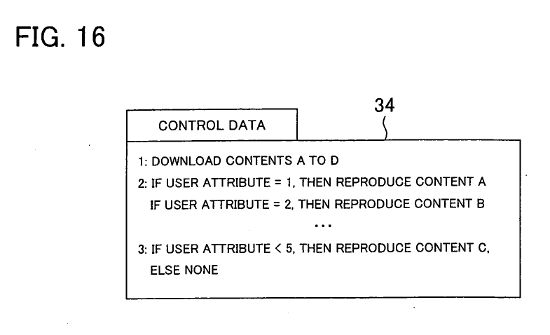

The content reproducing device 200 receives control data that specifies, for each user attribute value, which process the control section 150 performs in synchronism with a sync signal that the broadcast receiving section 111 receives thereat. A concrete example of the control data is illustrated in FIG. 16. Control data 34 illustrated in FIG. 16 designates such that if the user attribute value=1, reproduction of content A is to be started in response to a sync signal having an ID number 2, and that if the user attribute value=2, reproduction of content B is to be started in response to a sync signal having an ID number 2. Moreover, if the user attribute value <5, start reproduction of content c in response to a sync signal having an ID number 3, and no other process is to be performed.

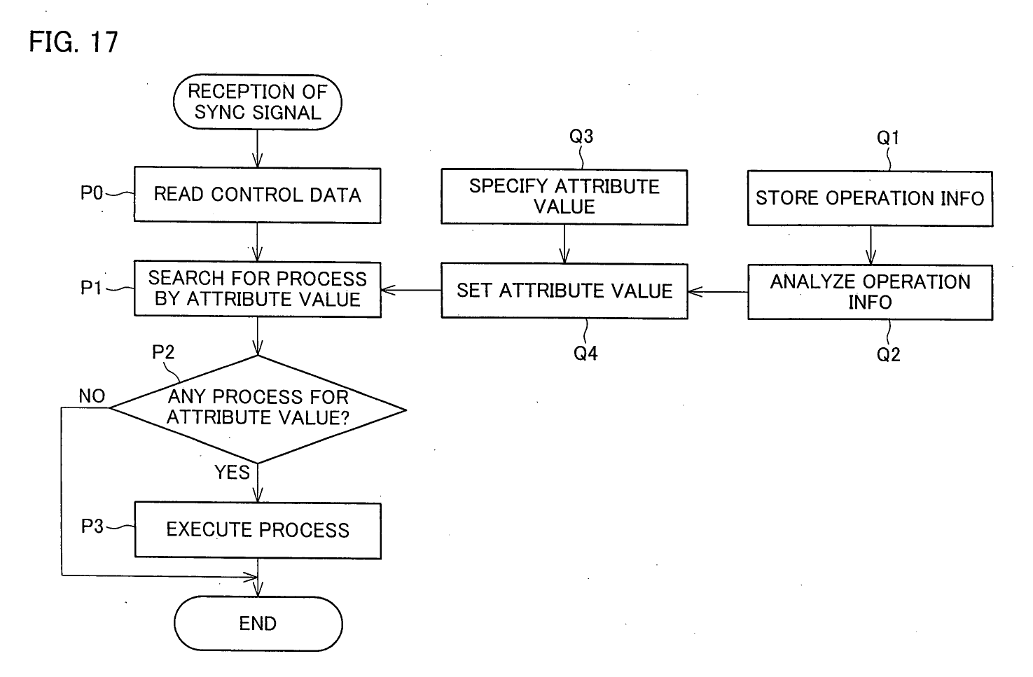

Referring to a flowchart of FIG. 17, the following describes a process performed by the content reproducing device 200 in response to the sync signal received at the broadcast receiving section 111. Upon receiving the sync signal from the sync signal extracting section 112, the content control section 152 reads out the control data from the control data storage section 122 (Step P0). After that, the content control section 152 acquires the user attribute value from the user attribute value setting section 154, and searches for, in the read-out control data, the process designated with respect to the user attribute value (Step P1). The control section 152 determines whether the control data specifies any process with respect to the user attribute value (Step P2). If the control data specifies a process with respect to the user attribute value (Step P2: Yes), then the control section 150 carries out the process. If the control data does not designate any process with respect to the user attribute value (Step P2: No), then the process is terminated.

The process until the user attribute value is set is explained below, referring to the flowchart of FIG. 17 again. When the user operates the operation section 161, operation information regarding the details of the operation is stored in the operation history storage section 162 by the control section 161 (Q1). After that, the user attribute value setting section 154 analyzes the operation history (Step Q2), and sets the user attribute value based on the operation history (Q4). This process may be arranged such that the user directly specifies the user attribute value. This step is referred to as Step Q3 in the flowchart of FIG. 17.

This arrangement of the present embodiment is applicable to various kinds of reproduction of broadcast programs.

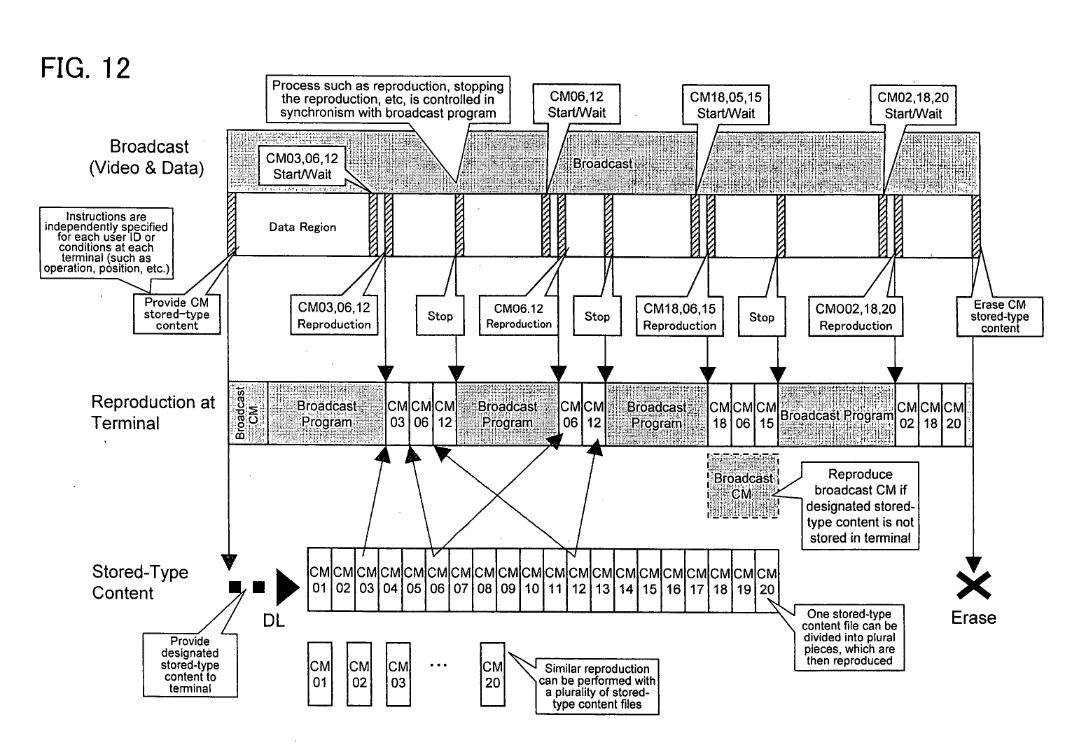

For example, when a good-purchasing program (television shopping program) which is watched by the user for purchase of goods, it is possible to reproduce stored-type content for introducing goods according to user's preference, which is worked out from history of channeling that the user have performed. This arrangement in which the stored-type content to be reproduced is selected based on the user's preference can be effectively applied to reproduction of a commercial message (broadcast program), reproduction of a preview (broadcast program) of a movie. FIG. 12 illustrates an example of application in which a commercial message is reproduced in replacement of part of the broadcast program by the content reproducing device 100 according to the present embodiment.

The user attribute setting means 154 may refer to a history of channeling at the same time one week before, and the user attribute setting means 154 operates to set a user attribute value of 1 to a broadcast program at a channel at this time if the channeling is set at the channel for a predetermined time period or longer, and set a user attribute value of 0 to this broadcast program if not. In this case, by using control data which if the user attribute value is 0 to a given sync signal, designates a process of downloading a content, which is a digest of programs broadcast in the last week, and if the user attribute value is 1 to the given sync signal, designates a process of downloading a content, which is a commercial message, it is possible to switch over the stored-type content to be reproduced based on whether the user watched the broadcast program or not.

The present invention is not limited to the above-mentioned arrangement in which the user attribute value is set by the user attribute value setting means 154. That is, the user attribute value can be any value that reflects an attribution of the user, such as a value obtained via the operation section 161 or the wireless communication section 121, a value worked out by the content reproducing device 200, or a value stored in a storage section of the content reproducing device 200. For example, positional information of the content reproducing device 200, which indicates a position of the content reproducing device 200 (that is, a position of the user holding the content reproducing device 200) may be used as the user attribute value. The positional information of the content reproducing device 200 may be determined by GPS (Global Positioning System) and acquired by a known method.

In case where the user attribute value is the positional information, it is possible to effectively use the content reproducing device 200 for the broadcast content such as a weather forecast program, a commercial message, and the like. That is, the content reproducing device 200 may be controlled as follows, for example: a part of the weather forecast program (broadcast program) may be replaced with a local weather forecast program (stored-type content) regarding an area in which the content reproducing device 200 locates; a part of a news program (broadcast program) may be replaced with a local news program (stored-type content) of the area; and the commercial message (broadcast content) may be replaced with a local commercial message that is specialized for the area.

(Modification 1)

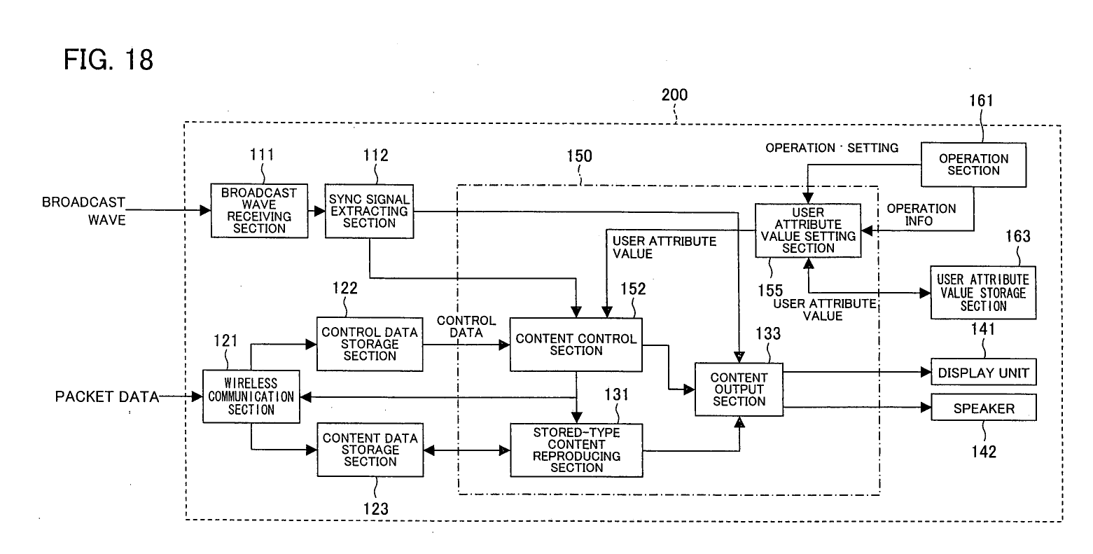

One modification of the content reproducing device 200 according to the present embodiment is described below according to FIG. 18. A content reproducing device 200 illustrated in FIG. 18 is modified in that a control section 150 includes a user attribute value setting section 155 for acquiring and analyzing operation information provided from an operation section 161 and setting a user attribute value based on the analysis. Moreover, the content reproducing device 200 of the present modification is further provided with a user attribute storage section 163 for storing the user attribute value therein.

The content reproducing device 200 of the modification as illustrated in FIG. 18 is arranged as follows: for example, when the user watching the broadcast program operates the operation section 161 in response to the content of the broadcast program, the details of the operation (operation information) is transmitted to the user attribute value setting section 155 immediately, and the user attribute value setting section 155 analyzes the operation information and sets the user attribute value.

For example, in case where the broadcast program being reproduced is a quiz program, an answer inputted by the user to a quiz questioned in the quiz program is transmitted to the user attribute value setting section 155, which judges whether the answer is correct or not. If a correct answer ratio of questions so far was stored in the user attribute storing section 163 as the user attribute value, the user attribute value setting 155 would calculate out a new correct answer ratio from the correct answer ration of the question so far and the result of the answer for the question currently questioned, and the new correct answer ratio would be stored in the user attribute storing section 163, so that the user attribute value is updated in the user attribute storing section 163. The operation performed by the user so far reflects the user attribute value thus updated.

The control data acquired by the content reproducing device 200 modified as illustrated in FIG. 18 is similar to the control data described above. That is, the control data in the present modification designates, for each user attribute value, a process to be carried out by the control section 150 in synchronism with a sync signal upon the reception of the sync signal by the broadcast wave receiving section 111.

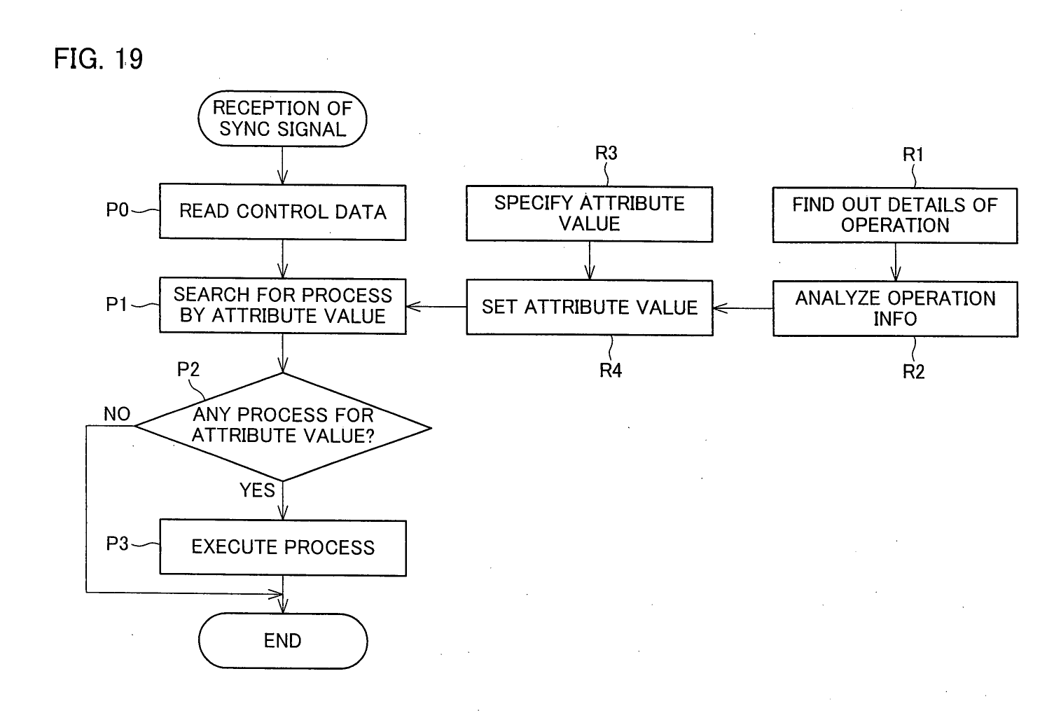

FIG. 19 illustrates a process performed in the content reproducing device 200 of the modification as illustrated in FIG. 18 when the broadcast wave receiving section 11 receives a sync signal. As illustrated in FIG. 19, the steps from designating, based on the set user attribute value, the process to be performed, and carrying out the designated process (Step P0 to P3) are identical with those illustrated in FIG. 17. The steps until the user attribute value is set are as follows. When the user operates the operation section 161, the user attribute value setting section 155 detects the operation (Step R1). The user attribute value setting section 155 analyzes the details of the detected operation (Step R2). The user attribute value setting section 155 sets the user attribute vale based on the result of the analysis (Step R4). Note that the present modification may be arranged such that the user attribute value is specified by the user directly. This step is indicated as step R3 in FIG. 19.

This arrangement of the present modification is applicable to various kinds of reproduction of broadcast contents, apart from the quiz program discussed above.

For example, in a case of a sport program such as a baseball program, the sport program (broadcast program) may be reproduced such that a part of the sport program is replaced with stored-type content that reflects the preference of the user, such as information on the teams, dugout information, etc. In this case, the user attribute value setting section 155 detects an operation of the operation section 161 by the user in response to a question, for example, to ask which team he likes, during the reproduction of the broadcast program. In this case, for example, if the user inputs a team name by operation the operation section 161, the user attribute value setting section 155 acquires, via a communication section 121 and from the broadcast program providing center 5, a table that associates the user attribute values with possible user inputs such as “black tigers: 1, white lions: 2, yellow dragons: 3”. The use attribute value setting section 155 looks up the table when setting the user attribute value based on the operation of the user.

(Modification 2)

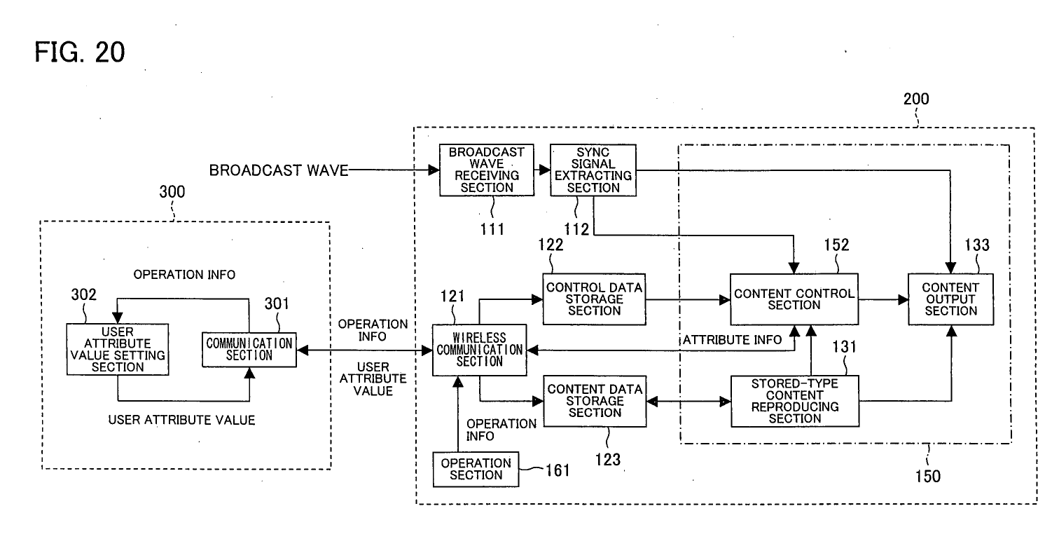

The content reproducing device 200 as illustrated in FIG. 18 may be arranged such that an external server device performs the function of setting the user attribute value. This kind of modification is described below, referring to FIG. 20.

FIG. 20 is a block diagram illustrating a part of a broadcast system in which a server provided externally performs the function of setting the user attribute value. The broadcast system illustrated in FIG. 20 includes a content reproducing devices 200 and a server device 300, at least.

The content reproducing device 200 illustrated in FIG. 20 is similar to the content reproducing device 200 illustrated in FIG. 18 except that the content reproducing device 200 illustrated in FIG. 20 is not provided with the user attribute value setting section 155 for performing the function of setting the user attribute value. The content reproducing device 200 is arranged such that when the user operates the operation section 161, operation information regarding the details of the operation is transmitted to the server device 300 via the wireless communication section 121.

The server device 300 is provided with a communication section 301 and a user attribute value setting section 302, at least. The communication section 301 receives the operation information transmitted thereto from the content reproducing device 200, and forwards the received operation information to the user attribute value setting section 302. The user attribute value setting section 302 analyzes the acquired operation information and sets the user attribute value. The user attribute value setting section 302 forwards the user attribute value to the communication section 301. The communication section 301 sends back the user attribute value to the content reproducing device 200.

The content reproducing device 200 acquires the user attribute value transmitted thereto from the server device 300 via the wireless communication section 121, and forwards the user attribute value to a content control section 152. The content control section 152 may be arranged such that a storage section (not illustrated) stores the user attribute value therein. This allows the content control section 152 to refer to the user attribute value any time.

It is possible to reduce a load on the content reproducing device 200 by arranging such that the server 300 provided externally performs the function of setting the user attribute value. Moreover, this arrangement allows to set the user attribute value flexibly according to the contents of the program on the air by changing the process of the user attribute setting section 302 according to the program on the air.

The present invention is not limited to the description of the embodiments above, but may be altered by a skilled person within the scope of the claims. An embodiment based on a proper combination of technical means disclosed in different embodiments is encompassed in the technical scope of the present invention.

The blocks of the content reproducing device, especially, the control section may be realized by way of hardware or software as executed by a CPU as follows:

The content reproducing device 100 includes a CPU (central processing unit) and a memory device (memory medium). The CPU (central processing unit) executes instructions in control programs realizing the functions. The memory device includes a ROM (read only memory) which contains programs, a RAM (random access memory) to which the programs are loaded, and a memory containing the programs and various data. The objects of the present invention can also be achieved by mounting to the content reproducing device 100 a computer-readable storage medium containing control program code (executable program, intermediate code program, or source program) for the content reproducing device 100, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy® disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The content reproducing device 100 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth, 802.11 wireless, HDR, mobile telephone network, satellite line, or terrestrial digital network. The present invention encompasses a carrier wave or data signal transmission in which the program code is embodied electronically.

The present invention is applicable to a content reproducing device for reproducing broadcast contents. Especially, the present invention is also applicable to a portable telephone terminal device capable of reproducing contents.

The content reproducing device according to the present invention is preferable arranged such that the control means controls the content reproducing device to perform, in synchronism with the reproduction of the broadcast content, at least one of storing a stored-type content in a content storing section and processing the stored-type content stored in the content storing section.

The broadcast content transmitting device broadcasts the broadcast content and the sync signal(s) in synchronism at an arbitrary timing. The content reproducing device receives the broadcast content together with the sync signal(s). The content reproducing device performs, in synchronism with the reproduction of the broadcast content, at least one of storing the stored-type content in the content storing section and processing the stored-type content stored in the content storing section. These processes, at least one of which is performed by the content reproducing device, are referred to as stored-type content process hereinafter. With the above arrangement, it is possible to perform the stored-type content process in synchronism with the broadcast content transmitted thereto.

For example, if the broadcast content transmitting device transmits a sync signal at the timing of switching the broadcast content from a first content to a second content, this arrangement allows the content reproducing device to perform the stored-type content process at the timing of switching from the reproduction of the first content to the reproduction of second content.

That is, with this arrangement, it is possible to provide a content reproducing device capable of performing a process regarding the stored-type content in synchronism with the broadcast content that is reproduced immediately after the reception of thereof.

Examples of the stored-type content process are, at least, the process of starting the reproduction of the stored-type content, the process of stopping the reproduction of the stored-type content, the process of externally acquiring the stored-type content and storing the stored-type content in the content storing section, and the process of erasing the stored-type content stored in the content storing section.

The stored-type content may be a content that is different from the broadcast content and that is externally acquired and stored in the content storing section, or a content that is a broadcast content receiving by the broadcast content receiving means and stored by the content storing section.

The content reproducing device according to the present invention preferably further comprises: control data acquiring means for externally acquiring control data that designates which process to be performed by the control means in synchronism with at least one of the sync signal(s), the control means performing the designated process when the broadcast content receiving means received the at least one of the sync signal(s).

With this arrangement, the control data designates the process to be performed by the control means upon the reception of the sync signal. Thus, in the content reproducing device, the process performed by the control signal in accordance with the sync signal can be changed according to the acquired control data.

Moreover, even if the same sync signal is broadcast to plural content reproducing devices, it is possible to cause the plural content reproducing devices to perform different stored-type content processes individually by providing different control data to each content reproducing device.

By changing the control data when necessary, it is possible to timely change the process (such as the stored-type content process or the like) to be performed.

The content reproducing device according to the present invention is preferably arranged such that for each sync signal that broadcast content receiving means sequentially receives, the control data designates which process to be performed by the control means in synchronism with which sync signal.

With this arrangement, the control data designates which process to be performed sequentially by the control means in accordance with the sync signal. Therefore, according to the control data acquired, the content reproducing device can change the process to be performed sequentially by the control means in accordance with the sync signal.

Moreover, even if the same sync signal is provided to plural content reproducing devices, it is possible to cause the plural content reproducing device to sequentially perform different stored-type content processes by providing different control data to each content reproducing device individually.

The content reproducing device according to the present invention is preferably arranged such that the control data contains process designating information for designating which process to be performed by the control means in synchronism with which sync signal; the sync signal(s) contains the process designating information; and the control means executes, by reference to the control data, the process designated by the process designating information contained in a given sync signal.

The sync signal contains the process designating information. By reference to the control data, the process designating information identifies which process to be performed in synchronism with the sync signal. That is, the control data designates the process to be performed in synchronism with the sync signal.

The control data is not particularly limited, as long as the control data relates the process designating information to the processes to be performed. Therefore, with this arrangement, it is possible to further reduce a information volume of the control data significantly compared with the arrangement in which for each sync signal sequentially received, the control data that designates which process to be performed. Furthermore, the control data is externally acquired. This makes it possible to significantly reduce time necessary to acquire the control data.

The content reproducing device is preferably arranged such that the control data designates, for each user attribute value, which process to be performed by the control means in synchronism with which sync signal.

According to this arrangement, the control data designates, for each user attribute value, which process to be performed by the control means in synchronism with the sync signal(s). Therefore, with this arrangement, depending on the user attribute values, it is possible to switch the processes to be performed by the control means in accordance with the sync signal. That is, with this arrangement, a process most suitable for the user can be performed by the control means in accordance with the sync signal.

The content reproducing device according to the present invention preferably further comprises user attribute value setting means for setting the user attribute values based on an operation history of user's operation stored in an operation history storing section.

According to this arrangement, the user attribute value is set based on the operation history, and the process to be performed is designated by the user attribute value. Therefore, with this arrangement, according to the operation history it is possible to cause the control means to perform different processes in accordance with the sync signal.

The content reproducing device may be provided with storage means for storing a look-up table that shows association between possible operation histories and particular user attribute values, or acquiring means for externally acquiring the look-up table, the user attribute value setting means setting the user attribute values by reference to the look-up table.

Alternatively, the user attribute value setting means may perform a predetermined calculation to work out the user attribute values from the possible operation histories thereby to set the user attribute value.

For example, for reproducing a broadcast program (broadcast content) such as a drama, the user attribute setting means may be arranged such that the user attribute value setting means refers to a history of switching the channels at the same time in one week before, and sets the user attribute value to 1 if a channel of the broadcast content is received for a predetermined time period or longer, but sets the user attribute value to 0 if not. If the control data is used which if the user attribute value=0, designates a process of downloading a content that is a digest of the content broadcasted last week, and if the user attribute value=1, designates a process of downloading a content that is a commercial message, the stored-contents to be reproduced can be switched based on whether or not the broadcast program was watched by the user.

The content reproducing device preferably further comprises user attribute value setting means for detecting user's operation and setting the user attribute values based on details of the user's operation.

With this arrangement, the user attribute value is determined based on the details of the user's operation, and the process to be performed is designated according to the user attribute value. Thus, with this arrangement, it is possible to perform different processes by the control means according to the details of the user's operation. That is, this arrangement makes it possible to carry out, in accordance with the sync signal, a process most suitable for the user. That is, the process to be performed in synchronism with the broadcast content can be switched according to user's input operation. In other words, an interactive reproduction of the broadcast content can be realized by this arrangement.

The content reproducing device may be provided with storage means for storing a look-up table that shows association between possible details of the user's operation and particular user attribute values, or acquiring means for externally acquiring the look-up table, the user attribute value setting means setting the user attribute values by reference to the look-up table.

Alternatively, the user attribute value setting means may perform a predetermined calculation to work out the user attribute values from the possible details of the user's operation thereby to set the user attribute value.

For example, in case where the user inputs an answer for a question asked in a quiz program (broadcast content), the look-up table may be such that 1 is allocated to a correct answer and 0 is allocated to a wrong answer. By referring to the look-up table, the user attribute value setting means can set the user attribute value to 1 for the input of a correct answer, but set the user attribute value to 0 for the input of a wrong answer.

The content reproducing device according to the present invention is preferably arranged such that the user attributes values are positional information that indicates where the content reproducing device is located.

With this arrangement, the user attribute value is set based on the positional information, and the process to be performed is designated according to the user attribute value. Thus, with this arrangement, it is possible to perform different processes by the control means in accordance with the sync signal depending of the location of the content reproducing device. Further, the location of the content reproducing device may be determined based on user's input or from information obtained by GPS or from a base station for portable telephones.

The content reproducing device according to the present invention is preferably comprises: operation information transmitting means for detecting user's operation and transmitting, to an external user attribute value providing device, operation information that indicates details of the user's operation; and user attribute value receiving means for receiving, from the user attribute value providing device, a user attribute value that the user attribute value providing device sets based on the operation information.

With this arrangement, the user attribute value is set based on the details of the user's operation and the process to be performed is designated according to the user's attribute value. Here, the process to set the user attribute value based on the details of the user's operation is carried out by the user attribute value providing device located externally. Thus, with this arrangement, it is possible to reduce the load on the content reproducing device in terms of setting the user attribute value.

This arrangement makes the present invention applicable for interactive broadcast content in which various users participate.

The content reproducing device according to the present invention is preferably arranged such that each sync signal received by the broadcast content receiving means respectively contains a control command that designates which process to be performed by the control means in synchronism with the sync signal; and when the broadcast content receiving means receives the sync signal, the control means executes the designated process, based on the control command contained in the sync signal.

With this arrangement, the process to be performed by the control means in accordance with the sync signal is designated by the control command contained in the sync signal. Therefore, with this arrangement, the timing when the stored-type content process is carried out can be controlled by controlling the timing of transmission of the sync signal. Further, by the control command contained in the sync signal, it is possible to specify which process to be performed.

The content reproducing device according to the present invention is preferably arranged such that the control means comprises video output means for outputting an image of the stored-type content in replacement of part or whole of an area in which an image of the broadcast content is displayed, or an image produced by combining the image of the stored-type content with part or whole of the image of the broadcast content, where the image of the stored-type content is an image reproduced from the stored-type content.

With this arrangement, the content reproducing device reproduces the stored-type content thereby to output, to a video output device such as a display unit, an image produced by replacing, with the image of the stored-type content, the part or whole of the area in which the broadcast content is displayed, or an image produced by combining the image of the stored-type content with the part or whole of the image of the broadcast content. Therefore, with this arrangement, the user can enjoy the stored-type content switched in synchronism with the broadcast content, or the image in which the image of the broadcast content and the stored-type content are combined.

The content reproducing device according to the present invention is preferably arranged such that the control means comprises: audio outputting means for outputting sound of the stored-type content in replacement of or concurrently with sound of the broadcast content, where the sound of the stored-type content is sound reproduced from the stored-type content.

With this arrangement, the content reproducing device reproduce the stored-type content to output, to a sound output device such as a speaker, the sound of the content reproducing device in replacement of the sound of the broadcast content, or sound in which the sound of the broadcast content and the stored-type content are mixed. Therefore, with this arrangement, the user can enjoy sound switched in synchronism with the broadcast content, or sound in which the sound of the broadcast content and the sound of the stored-type content are mixed.

The content reproducing device according to the present invention is preferably arranged such that the control means comprises: content output control means, which upon completion of reproduction of a stored-type content, switching over output of content from outputting the stored-type content to outputting the broadcast content reproduced by the broadcast content reproducing means.

With this arrangement, the broadcast content reproduced by the broadcast content reproducing means is outputted immediately even after unexpected abeyance of the reproduction of the stored-type content. Thus, the output of the content is continued without abeyance either by outputting the stored-type content or the broadcast content.

The content reproducing device is preferably arranged such that the control means comprises: content output control means for controlling content output in such a way that upon reception of a sync signal that instructs reproduction of a particular stored-type content, the content output control means switches over the content output from outputting the broadcast content to outputting the stored-type content if the particular stored-type content is stored in the content storage section, and keeps the content output of outputting the broadcast content if not.

According to this arrangement, when a sync signal that instructs the reproduction of the specific stored-type content is acquired, the specific stored-type content is outputted if the stored-type content is stored in the content storage section, and the broadcast content is continuously outputted if not. Therefore, with this arrangement, at least the output of the broadcast content is continued with no problem, even if the stored-type content is not stored in the content storage section at the time when the sync signal that instructs the reproduction of the stored-type content is received.

The content reproducing device according to the present invention is preferably arranged such that the control means comprises: stored-type content reproducing means, which starts the reproduction of the stored-type content when the broadcast content receiving means receives a second sync signal; and reproduction preparing means, which when the broadcast content receiving means receives a first sync signal before the second sync signal, causes the stored-type content reproducing means to be standby so that the stored-type content reproducing means is capable of starting the reproduction of the stored-type immediately.

Note that the first sync signal is a sync signal that causes the content reproducing device to be standby so that the content reproducing device is capable of starting reproduction of a stored-type content immediately, and the second sync signal is a sync signal that causes the content reproducing device to start the reproduction of the stored-type content.

Even if the second signal was received in order to start the reproduction of the stored-type content, the reproduction of the stored-type content might not be able to be started in response to the second sync signal in case the stored-type content reproducing means is not standby for immediate start of the reproduction of the stored-type content.

However, the content reproducing device according to the present invention is arranged such that the first sync signal is received before the second sync signal in order that the stored-type content reproducing means may be standby for immediate start of the reproduction of the stored-type content.

With this arrangement, the content reproducing means can start the reproduction immediately after receiving the second sync signal. That is, this arrangement can shorten a lag time from the reception of the second sync signal to the actual starting of the reproduction of the stored-type content.

To “cause the stored-type content reproducing means to be standby so that the stored-type content reproducing means is capable of starting the reproduction of the stored-type immediately” is, for example, to start, in advance, a program for realizing the function of the stored-type content reproducing means, so that the stored-type content reproducing means can function immediately.

The content reproducing device according to the present invention is preferably arranged such that the control means comprises: stored-type content reproduction means, which stops the reproduction of the stored-type content when the broadcast content reproducing means receives a third sync signal; and video output means, which when the stored-type content reproducing means completes the reproduction of the stored-type content, outputs an image of the stored-type content as a still image until the reception of the third sync signal by the broadcast content reproducing means.

Even if the broadcast content transmitting device transmits the third sync signal at a particular time in order to stop the reproduction of the stored-type content, there is a possibility that the reproduction of the stored-type content is completed before the content reproducing device receives the third sync signal.

However, with this arrangement, even if the reproduction of the stored-type content is completed, the video output means outputs the stored-type content image as a still image until the broadcast content receiving means receives the third sync signal. Therefore, with this arrangement, the image of the stored-type content is surely continued until the reception of the third sync signal.

The content reproducing device according to the present invention is preferably arranged such that in synchronism with the sync signal(s), the control means switches channels for the reception of the broadcast content receiving means.

With this arrangement, it is possible to switch channels for the reception of the broadcast content receiving means in accordance with the timing of the reception of the sync signal(s).

The broadcast content transmitting device according to the present invention is preferably arranged such that the broadcast content transmitting means transmits a first sync signal before transmitting a second sync signal, where the first sync signal is a sync signal that causes the content reproducing device to be standby so that the content reproducing device is capable of starting reproduction of a stored-type content immediately, and the second sync signal is a sync signal that causes the content reproducing device to start the reproduction of the stored-type content.

According to this arrangement, the broadcast content transmitting device transmits the first sync signal in order that the content reproducing device may be standby for immediate start of the reproduction of the stored-type content, and then transmits the second sync signal so as to cause the content reproducing device to start the reproduction of the stored-type content.

With this arrangement, it is possible to shorten a lag time from the transmission of the second sync signal to the start of the reproduction of the stored-type content.

The broadcast content transmitting device according to the present invention is preferably arranged such that the sync signal generating means generates a sync signal that contains a control command that designates which process to be performed by the content reproducing device in synchronism with this sync signal.

With this arrangement, the process to be performed by the content reproducing device in accordance with the sync signal is designated by the control command contained in the sync signal. Therefore, with this arrangement, by controlling the time of transmitting the sync signal, the broadcast content transmitting device can control the time at which the content reproducing device carries out the process. Further, the process to be performed can be specified by the control command contained in the sync signal.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A content reproducing device, comprising:
broadcast content receiving means for receiving a broadcast content together with a sync signal(s) multiplexed on the broadcast content;
broadcast content reproducing means for reproducing the broadcast content immediately after the broadcast content receiving means received the broadcast content; and
control means for controlling the content reproducing device in synchronism with the reproduction of the broadcast content in accordance with at least one of the sync signal(s).

2. The content reproducing device as set forth in claim 1, wherein:
the control means controls the content reproducing device to perform, in synchronism with the reproduction of the broadcast content, at least one of storing a stored-type content in a content storing section and processing the stored-type content stored in the content storing section.

3. The content reproducing device as set forth in claim 1, further comprising:
control data acquiring means for externally acquiring control data that designates which process to be performed by the control means in synchronism with at least one of the sync signal(s),
the control means performing the designated process when the broadcast content receiving means received the at least one of the sync signal(s).

4. The content reproducing device as set forth in claim 3, wherein:
for each sync signal that broadcast content receiving means sequentially receives, the control data designates which process to be performed by the control means in synchronism with which sync signal.

5. The content reproducing device as set forth in claim 3, wherein:
the control data contains process designating information for designating which process to be performed by the control means in synchronism with which sync signal;
the sync signal(s) contains the process designating information; and
the control means executes, by reference to the control data, the process designated by the process designating information contained in a given sync signal.

6. The content reproducing device as set forth in claim 3, wherein:
the control data designates, for each user attribute value, which process to be performed by the control means in synchronism with which sync signal.

7. The content reproducing device as set forth in claim 6, further comprising:
user attribute value setting means for setting the user attribute values based on an operation history of user's operation stored in an operation history storing section.

8. The content reproducing device as set forth in claim 6, further comprising:
user attribute value setting means for detecting user's operation and setting the user attribute values based on details of the user's operation.

9. The content reproducing device as set forth in claim 6, wherein:
the user attributes values are positional information that indicates where the content reproducing device is located.

10. The content reproducing device as set forth in claim 6, comprising:
operation information transmitting means for detecting user's operation and transmitting, to an external user attribute value providing device, operation information that indicates details of the user's operation; and
user attribute value receiving means for receiving, from the user attribute value providing device, a user attribute value that the user attribute value providing device sets based on the operation information.

11. The content reproducing device as set forth in claim 1, wherein:
each sync signal received by the broadcast content receiving means respectively contains a control command that designates which process to be performed by the control means in synchronism with the sync signal; and
when the broadcast content receiving means receives the sync signal, the control means executes the designated process, based on the control command contained in the sync signal.

12. The content reproducing device as set forth in claim 2, wherein:
the control means comprises:
video output means for outputting an image of the stored-type content in replacement of part or whole of an area in which an image of the broadcast content is displayed, or an image produced by combining the image of the stored-type content with part or whole of the image of the broadcast content, where the image of the stored-type content is an image reproduced from the stored-type content.

13. The content reproducing device as set forth in claim 2, wherein:
the control means comprises:
audio outputting means for outputting sound of the stored-type content in replacement of or concurrently with sound of the broadcast content, where the sound of the stored-type content is sound reproduced from the stored-type content.

14. The content reproducing device as set forth in claim 2, wherein:
the control means comprises:
content output control means, which upon completion of reproduction of a stored-type content, switching over output of content from outputting the stored-type content to outputting the broadcast content reproduced by the broadcast content reproducing means.

15. The content reproducing device as set forth in claim 2, wherein:
the control means comprises:
content output control means for controlling content output in such a way that upon reception of a sync signal that instructs reproduction of a particular stored-type content, the content output control means switches over the content output from outputting the broadcast content to outputting the stored-type content if the particular stored-type content is stored in the content storage section, and keeps the content output of outputting the broadcast content if not.

16. The content reproducing device as set forth in claim 2, wherein:
the control means comprises:
stored-type content reproducing means, which starts the reproduction of the stored-type content when the broadcast content receiving means receives a second sync signal; and
reproduction preparing means, which when the broadcast content receiving means receives a first sync signal before the second sync signal, causes the stored-type content reproducing means to be standby so that the stored-type content reproducing means is capable of starting the reproduction of the stored-type immediately.

17. The content reproducing device as set forth in claim 2, wherein:
the control means comprises:
stored-type content reproduction means, which stops the reproduction of the stored-type content when the broadcast content reproducing means receives a third sync signal; and
video output means, which when the stored-type content reproducing means completes the reproduction of the stored-type content, outputs an image of the stored-type content as a still image until the reception of the third sync signal by the broadcast content reproducing means.

18. The content reproducing device as set forth in claim 1, wherein:
in synchronism with the sync signal(s), the control means switches channels for the reception of the broadcast content receiving means.

19. A broadcast content transmitting device, comprising:
sync signal generating means for generating a sync signal(s) for causing a content reproducing device to operate in synchronism with reproduction of the broadcast content, the content reproducing device reproducing a broadcast content immediately after reception of the broadcast content; and
broadcast content transmitting means for transmitting the broadcast content together with the sync signal(s) multiplexed on the broadcast content.

20. The broadcast content transmitting device as set forth in claim 19, wherein:
the broadcast content transmitting means transmits a first sync signal before transmitting a second sync signal, where the first sync signal is a sync signal that causes the content reproducing device to be standby so that the content reproducing device is capable of starting reproduction of a stored-type content immediately, and the second sync signal is a sync signal that causes the content reproducing device to start the reproduction of the stored-type content.

21. The broadcast content transmitting device as set forth in claim 19, wherein:
the sync signal generating means generates a sync signal that contains a control command that designates which process to be performed by the content reproducing device in synchronism with this sync signal.

22. A control data providing device, comprising:
control data generating means for generating control data that designates which process to be performed by the content reproducing device in synchronism with the sync signal(s) when the content reproducing device receives the broadcast content together with the sync signal(s); and
control data transmitting means for transmitting the control data to the content reproducing device.

23. A user attribute value providing device, comprising:
operation information receiving means for receiving operation information from a content reproducing device;
user attribute value setting means for setting a user attribute value based on the operation information; and
user attribute value transmitting means for transmitting the user attribute value to the content reproducing device,
the content reproducing device performing a process according to the user attribute value in synchronism with reproduction of a broadcast content.

24. A broadcast system including a broadcast content transmitting device for transmitting a broadcast content, and a content reproducing device for reproducing the broadcast content immediately after receiving the broadcast content, wherein:
the broadcast content transmitting device comprises:
sync signal generating means for generating sync signal(s) for causing the content reproducing device to operate in synchronism with the reproduction of the broadcast content; and
broadcast content transmitting means for transmitting the broadcast content together with the sync signal(s) multiplexed on the broadcast content, and
the content reproducing device comprises:
broadcast content receiving means for receiving the broadcast content together with sync signal(s) multiplexed on the broadcast content;
broadcast content reproducing means for reproducing the broadcast content received by the broadcast content receiving means; and
control means for controlling the content reproducing device in synchronism with the reproduction of the broadcast content in accordance with at least one of the sync signal(s).

25. A broadcast system including a broadcast content transmitting device for transmitting a broadcast content, and a content reproducing device for reproducing the broadcast content immediately after receiving the broadcast content, wherein:
the broadcast content transmitting device comprises:
sync signal generating means for generating sync signal(s) for causing the content reproducing device to operate in synchronism with the reproduction of the broadcast content; and broadcast content transmitting means for transmitting the broadcast content together with the sync signal(s) multiplexed on the broadcast content,
the content transmitting means transmitting a first sync signal before transmitting a second sync signal, where the first sync signal is a sync signal that causes the content reproducing device to be standby so that the content reproducing device is capable of starting reproduction of a stored-type content immediately, and the second sync signal is a sync signal that causes the content reproducing device to start the reproduction of the stored-type content,
the content reproducing device comprises:
broadcast content receiving means for receiving the broadcast content together with sync signal(s) multiplexed on the broadcast content;
broadcast content reproducing means for reproducing the broadcast content received by the broadcast content receiving means; and
control means for controlling the content reproducing device in synchronism with the reproduction of the broadcast content in accordance with at least one of the sync signal(s), and
the control means comprises:
stored-type content reproducing means, which starts the reproduction of the stored-type content when the broadcast content receiving means receives a second sync signal; and
reproduction preparing means, which when the broadcast content receiving means receives a first sync signal before the second sync signal, causes the stored-type content reproducing means to be standby so that the stored-type content reproducing means is capable of starting the reproduction of the stored-type immediately.

26. A broadcast system including a broadcast content transmitting device for transmitting a broadcast content, and a content reproducing device for reproducing the broadcast content immediately after receiving the broadcast content, wherein:
the broadcast content transmitting device comprises:
sync signal generating means for generating sync signal(s) for causing the content reproducing device to operate in synchronism with the reproduction of the broadcast content; and broadcast content transmitting means for transmitting the broadcast content together with the sync signal(s) multiplexed on the broadcast content,
the sync signal generating means generating a sync signal that contains a control command that indicates which process to be performed by the content reproducing device in synchronism with this sync signal,
the content reproducing device comprises:
broadcast content receiving means for receiving the broadcast content together with sync signal(s) multiplexed on the broadcast content;
broadcast content reproducing means for reproducing the broadcast content received by the broadcast content receiving means; and
control means for controlling the content reproducing device in synchronism with the reproduction of the broadcast content in accordance with at least one of the sync signal(s), and
when the broadcast content receiving means receives the sync signal, the control means executing the designated process according to the control command contained in the sync signal.

27. A broadcast system comprising:
a broadcast content transmitting device for transmitting a broadcast content;
a content reproducing device for reproducing the broadcast content immediately after receiving the broadcast content; and
a control data providing device for providing control data to the content reproducing device,
the broadcast content transmitting device comprising:
sync signal generating means for generating sync signal(s) for causing the content reproducing device to operate in synchronism with the reproduction of the broadcast content; and broadcast content transmitting means for transmitting the broadcast content together with the sync signal(s) multiplexed on the broadcast content, and
the control data providing device, comprising:
control data generating means for generating control data that designates which process to be performed by the content reproducing device in synchronism with the sync signal(s) when the content reproducing device receives the broadcast content together with the sync signal(s); and
control data transmitting means for transmitting control data to the content reproducing device, and
the content reproducing device comprises:
broadcast content receiving means for receiving the broadcast content together with sync signal(s) multiplexed on the broadcast content;
broadcast content reproducing means for reproducing the broadcast content received by the broadcast content receiving means;
control means for controlling the content reproducing device in synchronism with the reproduction of the broadcast content in accordance with at least one of the sync signal(s); and
control data acquiring means for acquiring the control data from the control data providing device,
when the broadcast content receiving means receives the sync signal, the control means executing the designated process according to the control command contained in the sync signal.

28. A broadcast system comprising:
a broadcast content transmitting device for transmitting a broadcast content;
a content reproducing device for reproducing the broadcast content immediately after receiving the broadcast content; and
a user attribute value providing device for providing a use attribute value to the content reproducing device,
the broadcast content transmitting device comprising:
sync signal generating means for generating sync signal(s) for causing the content reproducing device to operate in synchronism with the reproduction of the broadcast content; and broadcast content transmitting means for transmitting the broadcast content together with the sync signal(s) multiplexed on the broadcast content, and
the content reproducing device comprising:
broadcast content receiving means for receiving the broadcast content together with sync signal(s) multiplexed on the broadcast content;
broadcast content reproducing means for reproducing the broadcast content received by the broadcast content receiving means;
control means for controlling the content reproducing device in synchronism with the reproduction of the broadcast content in accordance with at least one of the sync signal(s);
user attribute value setting means for detecting user's operation and setting the user attribute values based on details of the user's operation;
user attribute value receiving means for receiving, from the user attribute value providing device, a user attribute value that the user attribute value providing device sets based on the operation information;
control data acquiring means for externally acquiring control data that designates which process to be performed by the control means in synchronism with at least one of the sync signal(s),
the user attribute value providing device, comprising:
operation information receiving means for receiving operation information from the content reproducing device;
user attribute value setting means for setting the user attribute value based on the operation information; and
user attribute value transmitting means for transmitting the user attribute value to the content reproducing device.

29. A content reproducing method for use in a content reproducing device for receiving a broadcast content broadcast and reproducing the broadcast content immediately after the reception, the method comprising:
(a) receiving the broadcast content together with sync signal(s) multiplexed on the broadcast content;
(b) reproducing the broadcast content immediately after the broadcast content is received in the step (a); and
(c) controlling the content reproducing device in accordance with the sync signal in synchronism with the reproduction of the broadcast content (s).

30. A broadcast content transmitting method, comprising:
(a) generating a sync signal for causing a content reproducing device to operate in synchronism with reproduction of the broadcast content, the content reproducing device reproducing a broadcast content immediately after receiving the broadcast content and
(b) transmitting the sync signal together with the broadcast content on which the sync signal(s) are multiplexed, the sync signal(s) being generated in the step (a).

31. A program for causing a computer to function as the content reproducing device as set forth in claim 1,
the program causing the computer to function as each means provided in the content reproducing device.

32. A program for causing a computer to function as the broadcast content transmitting device as set forth in claim 19,
the program causing the computer to function as each means provided in the broadcast content transmitting device.

33. A program for causing a computer to function as the control data providing device as set forth in claim 22,
the program causing the computer to function as each means provided in the control data providing device.

34. A program for causing a computer to function as the user attribute value providing device as set forth in claim 23,
the program causing the computer to function as each means provided in the user attribute value providing device.

35. A computer-readable storage medium in which the program as set forth in claim 31 is stored.

36. A computer-readable storage medium in which the program as set forth in claim 32 is stored.

37. A computer-readable storage medium in which the program as set forth in claim 33 is stored.

38. A computer-readable storage medium in which the program as set forth in claim 34 is stored.
